(19) United States
(12) Patent Application Publication
(10) Pub. No.: US 2004/0215819 A1
(43) Pub. Date: Oct. 28, 2004

(54) Apparatus for and method for controlling packet, and computer program product

(75) Inventors: Tetsumei Tsuruoka, Kawasaki (JP); Naoki Oguchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/781,792

(22) Filed: Feb. 20, 2004

(30) Foreign Application Priority Data
Feb. 28, 2003 (JP) 2003-054409
May 20, 2003 (JP) 2003-142583

(51) Int. Cl. G06F 15/173

(52) U.S. Cl. 709/238

(57) ABSTRACT

A packet control system includes a packet forwarder and a packet control device. The packet forwarder includes a received packet transfer unit that transmits to the packet control device a routing information packet received from a network interface of the packet forwarder. The packet control device includes a virtual interface that has address information associated with the network interface; a transmitted packet reception unit; and a transmitted packet transfer unit. The transmitted packet reception unit receives the routing information packet, associates the routing information packet with the virtual interface, and transmits the routing information packet to the routing process. The transmitted packet transfer unit receives the routing information packet transmitted from the routing process, and transmits the routing information packet to the packet forwarder.

### BACKGROUND OF THE INVENTION

1) Field of the Invention

The present invention relates to a packet control system, a packet control device, a packet forwarding device, and a packet control program. More specifically, the present invention relates to a packet control system, a packet control device, a packet forwarder, and a packet control program capable of separating and cooperating a packet forwarding function of a router from or with a control function of the router without modifying a conventionally used routing application.

2) Description of the Related Art

Recently, as the development of the Internet progresses, networks have been made large in size and accelerated and service requirements have diversified. Accordingly, demand for a routing processing ability of a router that is a basic constituent device of an internet protocol (hereinafter, “IP”) network and for information processing resources including a memory that the router requires rapidly increases. In these circumstances, approaches have been taken to separate the router into a forwarder and a control device, to provide the control device that satisfies the rapidly increasing demand for the information processing resources, and co-operate the forwarder with the control device in the network.

For example, P1520 Reference Model [Gilad Goren] (doc), Documents, Foils and Minutes of the Fifth WG Meeting, held in Princeton (Jan. 18 to 19, 1999), which was obtained on http://www.ieee-pin.org/ by Internet search on Apr. 16, 2003, discloses a first conventional art which has been studied by the IEEE P1520WG for prescriptions of an interface (hereinafter, “IF”) between a forwarder function and a control function in relation to a communication device that constitutes a network in order to provide an integrated network.

Further, Proposed ForCES Requierments—Todd Anderson <Todd.a.Anderson.intel.com>(draft text) (ppt), Meetings—IETF, interim meetings, etc, IETF 50 ForCES/GSMP Joint Meeting, March 2001, Ninneapolis, Minn., USA, which was obtained on http://www.sstanamera.com/˜forces/ by Internet search on Apr. 16, 2003, discloses a second conventional art which has been studied by the Internet Engineering Task force (IETF) ForCES WG for architecture requirements and protocol requirements if the forwarding function of a router that constitutes a network is separated from the control function of the router.

Further, Japanese Patent Application Laid-open No. 2000-134214 discloses a third conventional art in which a control device and a forwarder are connected to an asynchronous transfer mode (ATM) network, the forwarder inquires the control device about a forwarding destination of a packet that the forwarder forwards, and the control device controls packet forwarding in response to the inquiry, thereby separating and co-operating the control function from and with the forwarding function.

In the second conventional art, the architecture requirements, the protocol requirements, and the like if the forwarding function and the control function of the router that constitutes the network are separated from and cooperated with each other are considered. However, the disadvantage which occurs when the forwarding function and the control function of the router that constitutes the network are separated and cooperated is not overcome yet.

For example, according to the third conventional art, the control device and the forwarder are connected to the ATM network, the forwarder inquires the control device about the forwarding destination of the packet that the forwarder forwarding, and the control device controls packet transfer in response to the inquiry, thereby separating and cooperating the control function and the forwarding function. However, it is disadvantageously necessary to greatly modify the conventional routing application.

### SUMMARY OF THE INVENTION

It is an object of the present invention to at least solve the problems in the conventional technology.

A packet control system according to one aspect of the present invention includes a packet forwarder that transfers a packet received from a network interface to another network interface; and a packet control device that routes the packet using a routing process. The packet forwarder includes a received packet transfer unit that transmits to the packet control device a routing information packet received from the network interface. The packet control device includes a virtual interface that has address information associated with the network interface of the packet forwarder; a transmitted packet reception unit that receives the routing information packet, that associates the routing information packet with the virtual interface, and that delivers the routing information packet to the routing process; and a transmitted packet transfer unit that receives the routing information packet sent by the routing process, and that transmits the routing information packet to the packet forwarder.

A packet control device according to another aspect of the present invention constructs a routing table for a packer forwarder controlled by the packet control device, using a routing process running on the packet control device. The packet control device includes a virtual interface that has address information associated with the network interface of the packet forwarder; a transmitted packet reception unit that receives the routing information packet transmitted from the packet forwarder, that associates the routing information packet with the virtual interface corresponding to an incoming network interface of the packet forwarder, and that transmits the routing information packet to the routing process; and a transmitted packet transfer unit that receives the routing information packet sent by the routing process, and that transmits the routing information packet to the packet forwarder.

A packet control device according to still another aspect of the present invention constructs a routing table for a packet forwarder controlled by the packet control device which determines an outgoing network interface of the packet received at an incoming network interface of the packet forwarder. The packet control device includes a plurality of network interfaces; and a plurality of virtual interfaces each having address information that is associated with one of the network interfaces of the packet forwarder, the network interfaces of the packet control device and the virtual interfaces being divided into a plurality of groups. The packet control device also routes the packet using a routing process associated with each of the groups considering interfaces belongs to the groups to create a dedicated routing table for each, the each of the groups corresponds to a separate device.

A packet forwarder according to still another aspect of the present invention forwards a packet from its network interface to its other network interface according to its routing table. The packet forwarder includes a received packet transfer unit that transmits a routing information packet received at the network interface to a packet control device that maintains the routing table of the packet forwarder using a routing process.

A method of maintaining a routing table using a routing process according to still another aspect of the present invention includes receiving a routing information packet which is received by a packet forwarder; associating the routing information packet with a virtual interface that has address information associated with a network interface of the packet forwarder; delivering the routing information packet to the routing process; receiving the routing information packet sent by the routing process; and transmitting the routing information packet to the packet forwarder for transmitting from its network interface.

A method according to still another aspect of the present invention is of maintaining a routing table in a system that includes a packet forwarder and a packet control device. The packet forwarder includes a plurality of network interfaces. The packet control device includes a plurality of network interface and a plurality of virtual interfaces each having address information that is associated with one of the network interfaces of the packet forwarder. The method includes dividing the network interfaces of the packet control device and the virtual, interfaces into a plurality of groups; and maintaining a routing table of each of the group using a routing process associated with each of the groups.

A method of maintaining a routing table according to still another aspect of the present invention includes receiving a routing information packet from a network interface of a packet forwarder; and transferring the routing information packet to a packet control device.

A router control device according to still another aspect of the present invention includes a virtual interface setting unit that creates and manages virtual interfaces on a router control device according to corresponding network interfaces of a forwarder; a routing unit that generates a routing table for the forwarder based on routing information in routing information packets received at the network interface of the forwarder and transferred by the forwarder to the router control device; and a routing information storage unit that stores a routing table created and managed by the routing unit for packet forwarding between the virtual interfaces.

A router control system according to still another aspect of the present invention includes a forwarder and a router control device. The router control device includes a virtual interface setting unit that that creates and manages virtual interfaces on a router control device according to corresponding network interfaces of a forwarder; a tunnel transfer unit that transfers the routing information packet via a communication path that connects between the network interface and the virtual interface; a routing information storage unit that stores routing information in the routing information packet transferred by the tunnel transfer unit; a routing unit that generates the routing table for the forwarder based on the routing information stored in the routing information storage unit; and the routing table transmission unit that acquires the routing table, and transmits the routing table to the forwarder. The forwarder forwards a packet from its network interface to its other network interface according to its routing table, and includes a received packet transfer unit that transmits a routing information packet received at the network interface to the router control device that maintains the routing table of the forwarder using a routing process.

A method of maintaining a routing table according to still another aspect of the present invention includes creating and managing virtual interfaces on a router control device according to corresponding network interfaces of a forwarder; generating a routing table for the forwarder based on routing information in routing information packets received at the network interface of the forwarder and transferred by the forwarder to the router control device; and storing a routing table created and managed by the routing unit for packet forwarding between the virtual interfaces.

A method of maintaining a routing table according to still another aspect of the present invention includes creating and managing virtual interfaces on a router control device according to corresponding network interfaces of a forwarder; transferring the routing information packet by tunneling via a communication path that connects between the network interface and the virtual interface; storing routing information on the routing information in the routing information packet transferred; generating a routing table for the forwarder based on the routing information stored; acquiring the routing table; transmitting the routing table to the forwarder; forwarding a packet from a network interface of the forwarder to other network interface of the forwarder according to a routing table of the forwarder; and transmitting a routing information packet received at the network interface of the forwarder to the router control device that maintains the routing table of the forwarder using a routing process.

The computer program product according to still another aspect of the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1A illustrates the concept of a conventional router, and FIG. 1B illustrates the concept of a packet control system in a first embodiment of the present invention;

FIG. 2 is a functional block diagram of the configuration of the packet control system in the first embodiment;

FIG. 3 illustrates one example of a virtual communication path management table of a packet control device shown in FIG. 2;

FIG. 4 illustrates one example of a connection management table of the packet control device shown in FIG. 2;

FIG. 5 illustrates one example of a virtual I/F management table of the packet control device shown in FIG. 2;

FIG. 6 illustrates one example of a virtual communication path management table of a packet forwarder shown in FIG. 2;

FIG. 7 illustrates one example of a virtual I/F management table of the packet forwarder shown in FIG. 2;

FIG. 8 is a flow chart illustrating steps of procedures for setting a virtual I/F and a virtual communication path of the packet control system shown in FIG. 2;

FIG. 9 is a flow chart illustrating steps of procedures for transmitting a packet of the packet control system shown in FIG. 2;

FIG. 10 is a flow chart illustrating steps of procedures for receiving the packet of the packet control system shown in FIG. 2;

FIG. 11 is a flow chart illustrating steps of procedures for transferring a routing table of the packet control system shown in FIG. 2;

FIG. 12 illustrates the concept of grouping the virtual I/F's of the packet control system in a second embodiment of the present invention;

FIG. 13 illustrates one example of the configuration of a network to which the packet control system shown in FIG. 12 is applied;

FIG. 14 illustrates another example of the configuration of a network to which the packet control system shown in FIG. 12 is applied;

FIG. 15 illustrates still another example of the configuration of a network to which the packet control system shown in FIG. 12 is applied;

FIG. 16 illustrates still another example of the configuration of a network to which the packet control system shown in FIG. 12 is applied;

FIG. 17A illustrates the concept of a conventional router, and FIG. 17B illustrates the concept of a router in a third embodiment of the present invention;

FIG. 18 is a functional block diagram of the configuration of a router control system in the third embodiment;

FIG. 19 is a flow chart illustrating steps of procedures for setting the virtual I/F of the router control system shown in FIG. 18;

FIG. 20 illustrates one example of communication paths generated at the steps of procedures for setting the virtual I/F of the router control system shown in FIG. 18;

FIG. 21 is a flow chart illustrating steps of procedures for transferring the received packet of the router control system shown in FIG. 18;

FIG. 22 is a flow chart illustrating steps of procedures for transferring the transmitted packet of the router control system shown in FIG. 18;

FIG. 23 is a flow chart illustrating steps of procedures for setting a routing table of the router control system shown in FIG. 18;

FIG. 24 illustrates one example of communication paths generated at the steps of procedures for transferring the packet and those for setting the routing table of the router control system shown in FIG. 18;

FIG. 25 is a system block diagram of the configuration of a computer system in a fourth embodiment of the present invention; and

FIG. 26 is a block diagram of the configuration of a main body section of the computer system shown in FIG. 25.

### DETAILED DESCRIPTION

Exemplary embodiments of a packet control system, a packet control device, a packet forwarding device, and a packet control program according to the present invention will be explained hereinafter in detail with reference to the accompanying drawings. In the first embodiment, an example in which the packet control system according to the present invention is applied to a router that is separated into a packet control device and a packet forwarding device will be explained. In the second embodiment, an example in which the configuration of a network to which the packet control system according to the present invention is applied will be explained. In the third embodiment, an example in which the router control device according to the present invention is applied to a router control system will be explained. In the fourth embodiment, a computer system that executes the router control system will be explained. Finally, various modifications as the other embodiments will be explained.

In a first embodiment, the example in which the packet control system according to the present invention is applied to the router separated into the packet control device and the packet forwarding device will be explained. The outline and features of the packet control system in the first embodiment will be explained first, the configuration of the packet control system will be explained next, and steps of procedures for setting an I/F and a virtual communication path of the packet control system, steps of procedures for forwarding a packet thereof, and steps of procedures for receiving a packet thereof will be finally explained.

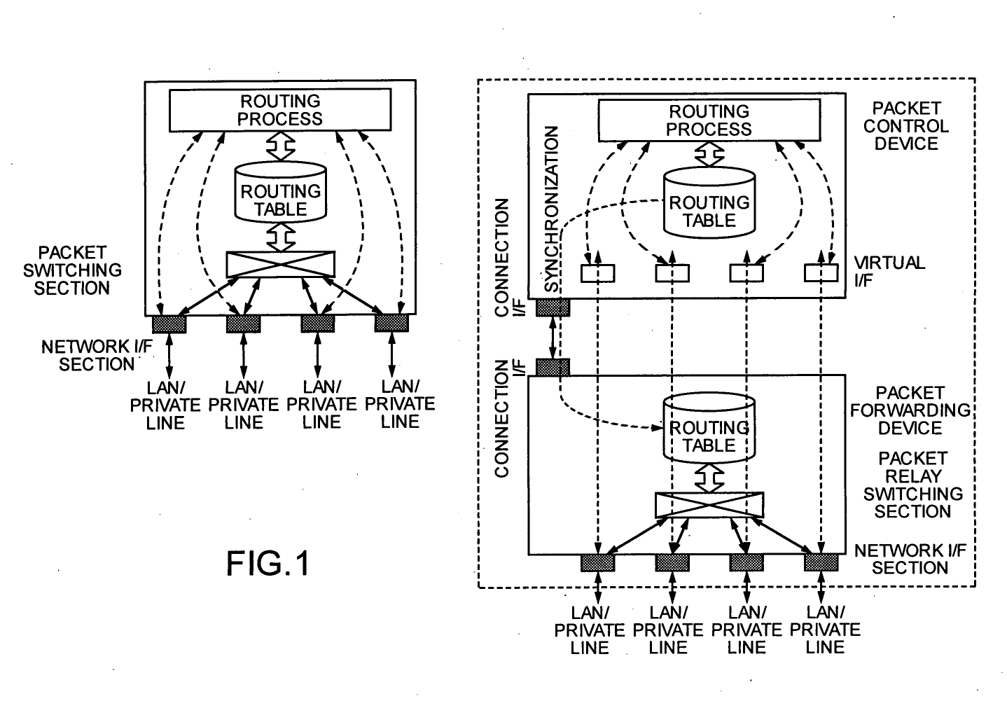

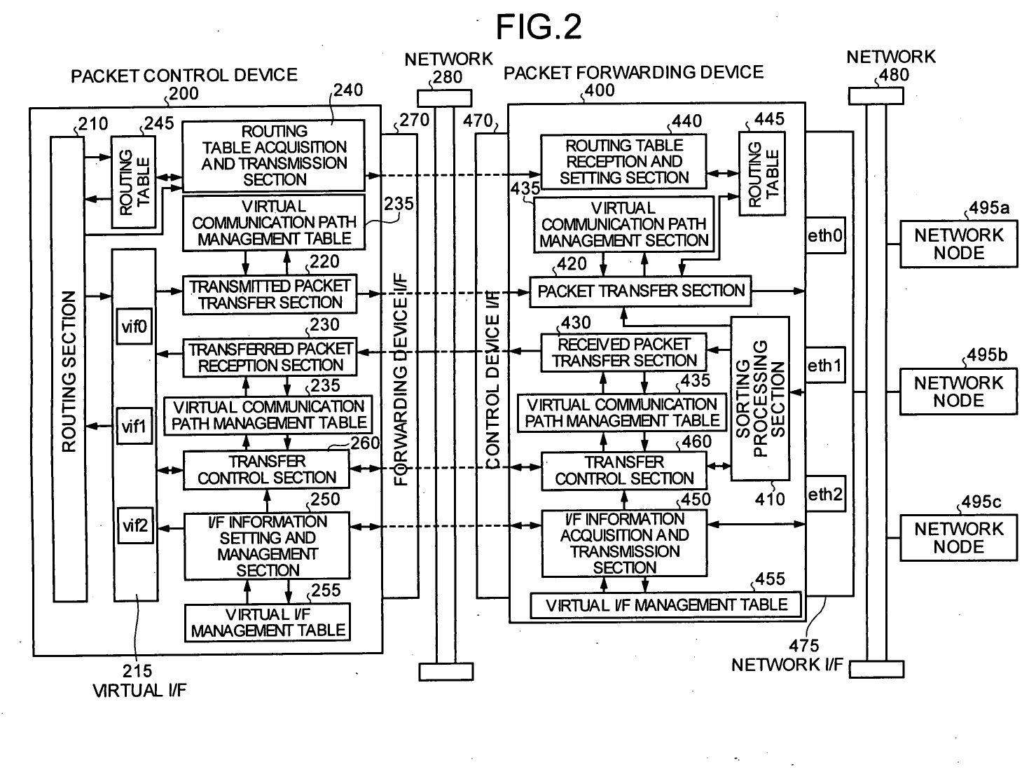

The outline and main features of the packet control system in the first embodiment will first be explained. FIGS. 1A and 1B illustrate the concept of the packet control system in the first embodiment. FIG. 2 is a functional block diagram of the configuration of the packet control system in the first embodiment.

As shown in FIG. 1A, in a conventional router, a packet switching section transmits and receives a packet using a network I/F with a local area network (hereinafter, “LAN”) or a dedicated line based on a destination address of the packet and a routing table. A routing processing section decides on a path to be selected based on network I/F information and routing information which the router exchanges with the other router in the network according to an algorithm prescribed by a routing protocol, sets and registers the decided path as the routing table, and controls a packet transfer path.

As shown in FIG. 1B, the packet control system according to the present invention is constituted so that the packet forwarding device which transmits and receives a packet using a network I/F and the packet control device which routes a packet using a routing processing section are connected to each other. In the packet control system, the forwarding function and the control function of the router can be separated and cooperated without modifying the conventionally used routing application.

Specifically, the first aspect of the present invention provides the packet control system, wherein the packet forwarding device 400 transfers a routing information packet received at the network I/F 475 to the packet control device 200, and in that the packet control device 200 receives the routing information packet which is transferred from a virtual I/F 215 which holds address information associated with the network I/F 475 and the packet forwarding device 400, transfers the received routing information packet to the routing processing section while making the packet associate with the virtual I/F 215, and let a routing section 210 receive the routing information packet delivered while being made to associate with the virtual I/F 215 and transfer the routing information packet to the packet forwarding device 400. It is thereby possible to provide an operation environment equivalent to that in which the routing application operating on the packet control device 200 operates on the packet forwarding device 400. Therefore, the forwarding function and the control function of the router can be separated and cooperated without modifying the conventionally used routing application.

The configuration of the packet control system in the first embodiment will be explained. As shown in FIG. 2, the packet control system consists of the packet control device 200, the packet forwarding device 400, network nodes 495a to 495c, a network 280 which connects the packet control device 200 to the packet forwarding device 400, and a network 480 which connects the packet forwarding device 400 to the network nodes 495a to 495c.

The networks 280 and 480 are dedicated lines such as LAN's or IP networks such as the Internet. The network nodes 495a to 495c are routers, communication terminal devices or the like that hold packet communication according to the IP protocol.

The packet control device 200 consists of the routing section 210, the virtual I/F 215, a transmitted packet transfer section 220, a transferred packet reception section 230, a virtual communication path management table 235, a routing table acquisition and transmission section 240, a routing table 245, an I/F information acquisition section 250, a transfer control section 260, and a control device I/F 270.

The routing section 210 is a protocol software which generates the routing table 245 for the virtual I/F 215 based on routing information on the data packet received at the network I/F 475, and which transfers the data packet based on the routing table 245. Specifically, the routing section 210 acquires the routing information from the other router according to the routing protocol such as a routing information protocol (RIP) or an open shortest path first (OSPF), calculates a path based on the routing information, and generates the routing table 245.

The virtual I/F 215 is an I/F of the packet control device 200 virtually set to correspond to the network I/F 475 of the packet forwarding device 400. The transmitted packet transfer section 220 is a processing section which receives the packet transmitted from the routing section 210 to the virtual I/F 215 and which transfers the received packet to the packet forwarding device 400.

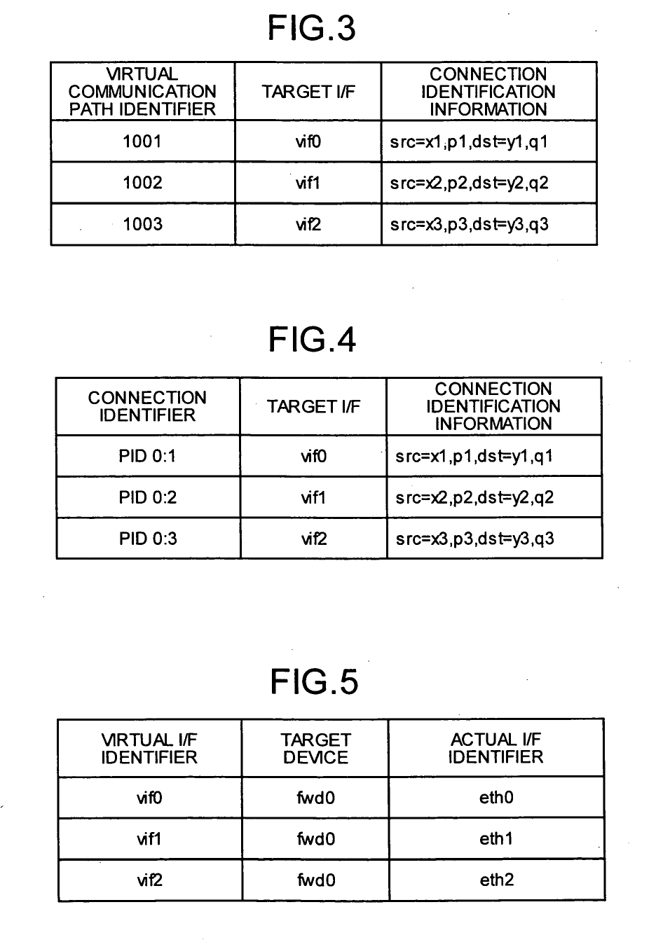

The transferred packet reception section 230 is a processing section which receives the packet transferred from the packet forwarding device 400 and which transfers the received packet to the routing section 210 while making the packet associate with the virtual I/F 215. The virtual communication path management table 235 is a table which makes a virtual communication path identifier, a virtual I/F, and an address and a port number of a sender/an address and a port number of a destination associate with one another. One example of the virtual communication path management table 235 of the packet control device shown in FIG. 2 will be explained. FIG. 3 illustrates one example of the virtual communication path management table 235 of the packet control device shown in FIG. 2. Specifically, the table 235 makes virtual communication path identifiers 1001, 1002, and 1003 associate with target I/F's vif0, vif1, and vif2 and connection identifiers src=x1, p1, dst=y1, q1; src=x2, p2, dst=y2, q2; and src=x3, p3, dst=y3, q3, respectively. In FIG. 3, symbol src denotes the sender, dst denotes the destination, x1 to x3 and y1 to y3 denote addresses, and p1 to p3 and q1 to q3 denote port numbers. A connection management table, not shown in FIG. 2 but shown in FIG. 4, is a table which manages a virtual communication path used by the routing section 210. In FIG. 4, connection identifiers PID0: 1 to 3 indicate virtual communication paths 1 to 3 each having an ID of PID0 for identifying the routing section 210. Among the virtual communication paths shown in FIG. 4, the virtual communication path using the virtual I/F 215 for data transmission and reception is registered in the virtual communication path management table 235.

The routing table acquisition and transmission section 240 is a processing section which acquires the routing table 245 generated by the routing section 210 and which transmits the acquired routing table 245 to the packet forwarding device 400. Specifically, if the routing section 210 notifies the routing table acquisition and transmission section 240 of the update of the routing table 245, the routing table acquisition and transmission section 240 acquires the routing table 245 and transmits the routing table 245 to the forwarding device 400.

The routing table 245 is a table which makes an IP address of the destination of the packet associate with an IP address of the next transfer destination. In other words, the routing table 245 is a table which defines a communication path to the destination of the packet obtained as a result of routing exerted by the routing section 210.

The I/F information setting and management section 250 is a processing section which acquires information on the network I/F 475 from the packet forwarding device 400, sets the virtual I/F 215, registers the virtual I/F 215 in the virtual I/F management table 255, and which manages the virtual I/F 215. The virtual I/F management table 255 is a table which manages the virtual I/F 215 and the network I/F 476 while making them associate with each other. Specifically, a kernel of an operating system manages the virtual I/F 215 and the network I/F 475. One example of the virtual I/F management table 255 of the packet control device 200 shown in FIG. 2 will be explained. FIG. 5 illustrates one example of the virtual I/F management table 255 of the packet control device 200 shown in FIG. 2. Specifically, the virtual I/F management table 255 is a table which makes virtual I/F identifiers vf0, vif1, and vif2, the target device fwd0, and actual I/F identifiers eth0, eth1, and eth2 associate with one another, respectively.

The transfer control section 260 detects that the routing section 210 generates a communication port and accesses the virtual I/F 215, registers a virtual communication path in the virtual communication path management table 235, and requests the packet forwarding device 400 to register the virtual communication path. The control device I/F 270 is an interface for communicating with the packet forwarding device 400 through the network 280.

The packet forwarding device 400 consists of a sorting processing section 410, a packet transfer section 420, a received packet transfer section 430, a virtual communication path management table 435, a routing table reception and setting section 440, a routing table 445, an I/F information acquisition and transmission section 450, an I/F management table 455, a transfer control section 460, a forwarding device I/F 470, and a network I/F 475.

The sorting processing section 410 is a processing section which checks the destination of the packet received at the network I/F 475 from a header thereof, transfers the packet to the received packet transfer section 430 if the packet is addressed to the packet forwarding device 400, and which sorts the packet to the packet transfer section 420 if the packet is addressed to the other device. The packet transfer section 420 is a processing section which transfers the packet received at the network I/F 475 of the packet forwarding device 400 based on the routing table 445.

The received packet transfer section 430 is a processing section which searches the virtual communication path from the virtual communication path management table 435 based on connection identification information on the packet transferred from the sorting processing section 410, i.e., an address and a transmission control protocol (TCP) port number of the sender/an address and a TCP port umber of the destination, and transfers the packet to the packet control device 200 using the virtual communication path.

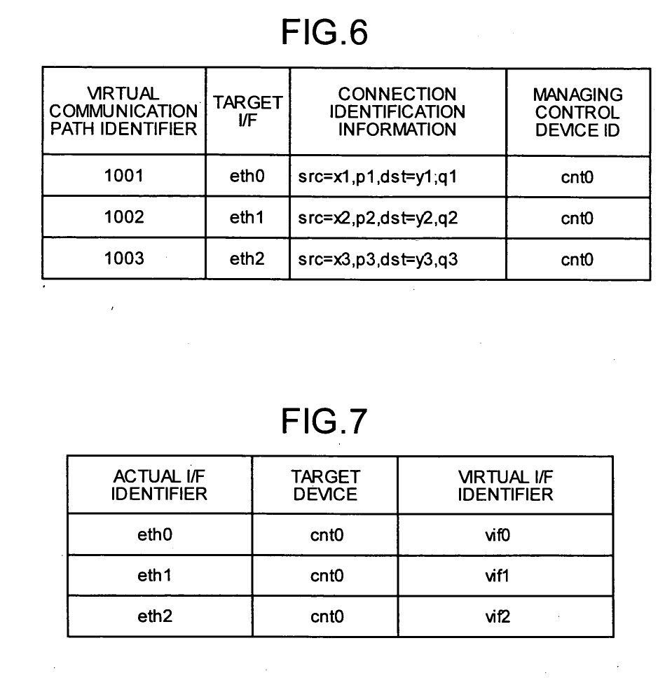

The virtual communication path management table 435 is a table which makes a virtual communication path identifier, the virtual I/F, and the address and port number of the sender/the address and port number of the destination associate with one another. One example of the virtual communication path management table 435 of the packet forwarding device 400 shown in FIG. 2 will be explained. FIG. 6 illustrates one example of the virtual communication path management table 435 of the packet forwarding device 400 shown in FIG. 2. Specifically, the virtual communication path management table 435 is a table which makes virtual communication path identifiers 1001, 1002, and 1003, target I/F's eth0, eth1, eth2, connection identifiers src=x1, p1, dst=y1, q1; src=x2, p2, dst=2, q2; and src=x3, p3, dst=3, q3, and managing control device ID cnt0 associate with one another, respectively.

The routing table reception and setting section 440 is a processing section which updates the routing table 445 based on the routing table 245 transmitted from the packet control device 200. The routing table 445 is a table which makes the IP address of the packet destination associate with the IP address of a router or a host which is the next transfer destination. In other words, the routing table 445 is a table which defines a transfer destination of the transfer target packet obtained as a result of the routing exerted by the routing section 210.

The I/F information acquisition and transmission section 450 is a processing section which acquires information on the network 475 and transmits the information to the packet control device 200 if the I/F information setting and management section 250 of the packet control device 200 requests the packet forwarding device 400 to transmit the I/F information on the packet forwarding device 400. The virtual I/F management table 455 is a table which manages the virtual I/F 215 and the network I/F 475 while making them associate with each other. One example of the virtual I/F management table 455 of the packet forwarding device 400 shown in FIG. 2 will be explained. FIG. 7 illustrates one example of the virtual I/F management table 455 of the packet forwarding device 400 shown in FIG. 2. Specifically, the virtual I/F management table 455 is a table which makes the actual I/F identifiers eth0, eth1, and eth2, the managing control device ID cnt0, and the virtual I/F identifiers vh0, vif1, and vif2 associate with one another, respectively.

The transfer control section 460 is a processing section which registers the virtual communication path in the virtual communication path management table 435 if the packet control device 200 requests the packet forwarding device 400 to register the virtual communication path. The forwarding device I/F 470 is an interface for communication with the packet control device 200 through the network 280. The network I/F 475 is an interface for communication with the network nodes 495a to 495c through the network 480.

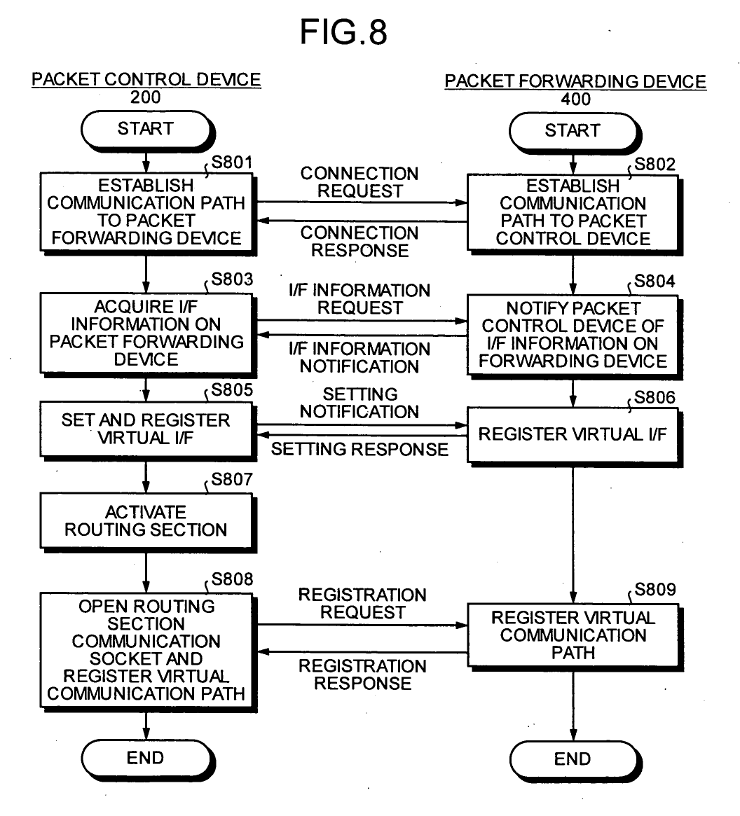

Steps of procedures for setting the virtual I/F and the virtual communication path of the packet control system shown in FIG. 2 will be explained. FIG. 8 is a flow chart of the steps of procedures for setting the virtual I/F and the virtual communication path of the packet control system shown in FIG. 2.

As shown in FIG. 8, the packet control device 200 requests the packet forwarding device 400 to connect the communication path to the packet forwarding device 400 through the control device I/F 270 and the forwarding device I/F 470, and the packet forwarding device 400 establishes the communication path in response to the request of the packet control device 200 (at steps S801 and S802). The I/F information setting and management section 250 of the packet control device 200 requests the packet forwarding device 400 to transmit the I/F information to the packet control device 200 so as to know the network I/F 475 of the packet forwarding device 400 (at step S803). The I/F information acquisition and transmission section 450 of the packet forwarding device 400 acquires the I/F information and notifies the packet control device 200 of the I/F information in response to the request of the packet control device 200 (at step S804).

The I/F information setting and management section 250 of the packet control device 200 sets the virtual I/F 215 while making the virtual I/F 215 associate with the acquired network I/F 475, registers the virtual I/F 215 and the network I/F 475 in the virtual I/F management table 255, and notifies the packet forwarding device 400 of the setting of the virtual I/F 215 (at step S805). The packet forwarding device 400 registers the virtual I/F 215 in the virtual I/F management table 455 based on the notification from the packet control device 200 and responds to the notification from the packet control device 200 (at step S806).

If the routing section 210 of the packet control device 200 is activated (at step S807), the routing section 210 opens a communication socket so as to hold packet communication with the other network nodes 495a to 495c, and prepares for transmitting and receiving messages. On the occasion of the opening of the socket by the routing section 210, the transfer control section 260 of the packet control device 200 registers the virtual communication path corresponding to the socket in the virtual communication path management table 235 and requests the packet forwarding device 400 to register the virtual communication path (at step S808). The transfer control section 460 of the packet forwarding device 400 registers the virtual communication path in the virtual communication path management table 435 in response to the request of the packet control device 200 (at step S809).

These steps of procedures for setting the virtual communication path are executed a plurality of times corresponding to the number of sockets opened by the routing section 210. If the routing section 210 acquires the routing information from the other router according to the RIP, the routing section 210 opens one socket per I/F. If the protocol is a routing protocol such as a border gateway protocol (BGP) that can designate the router with which the packet control device 200 exchanges the routing information independently of the I/F, the number of sockets to be opened changes depending on a setting or operation state.

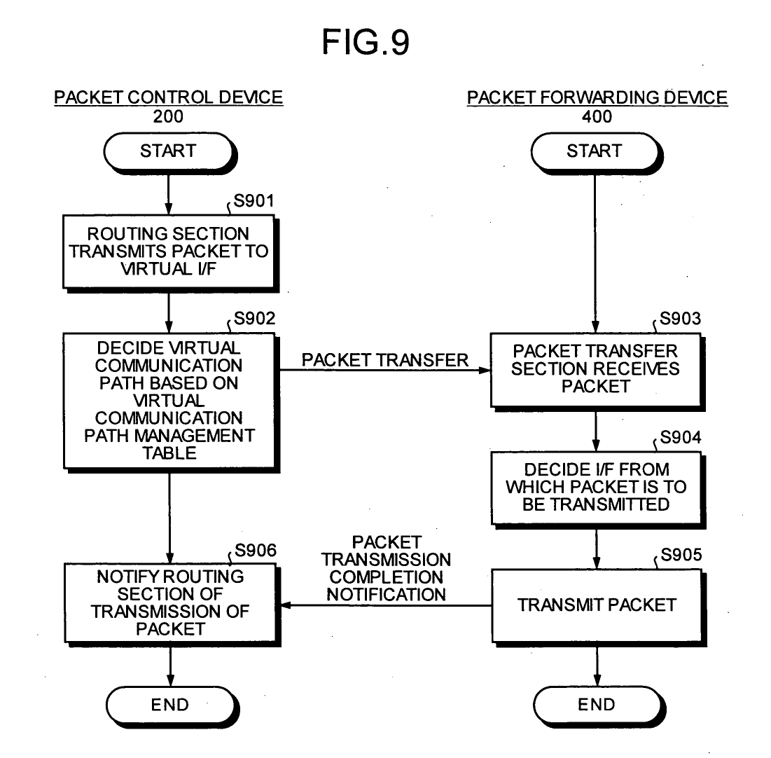

Steps of procedures for forwarding the packet of the packet control system shown in FIG. 2 will be explained next. FIG. 9 is a flow chart of the steps of procedures for forwarding the packet of the packet control system shown in FIG. 2.

As shown in FIG. 9, if the routing section 210 of the packet control device 200 forwards the packet to the virtual I/F 215 (at step S901), the forwarded packet transfer section 220 decides on the virtual communication path based on the virtual communication path management table 235 and transfers the virtual communication path to the packet forwarding device 400 (at step S902). The packet transfer section 420 of the packet forwarding device 400 receives the packet (at step S903), decides on the network I/F 475 corresponding to the virtual communication path from the virtual communication path management table 435 (at step S904), and forwards the packet from the network I/F 475 (at step S905). The packet transfer section 420 notifies the routing section 210 of the packet control device 200 of the completion of the transmission of the packet (at step S906).

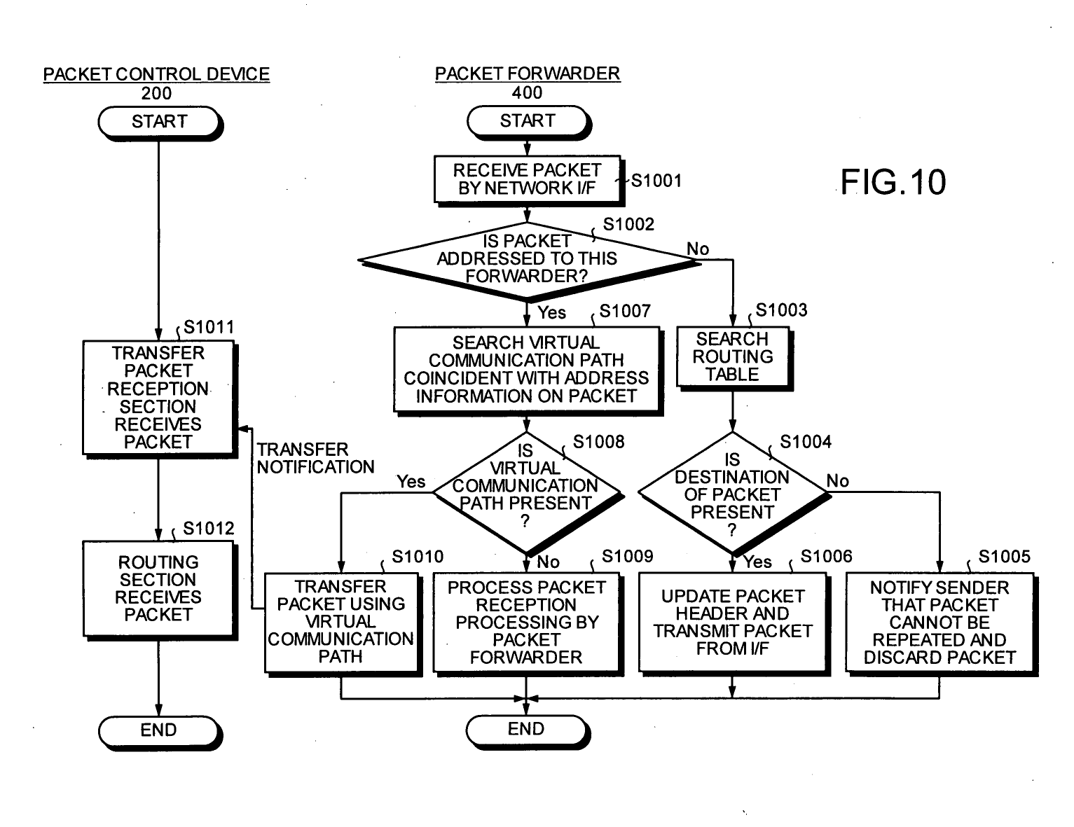

Steps of procedures for receiving the packet of the packet control system shown in FIG. 2 will be explained next. FIG. 10 is a flow chart of the steps of procedures for receiving the packet of the packet control system shown in FIG. 2.

If the network I/F 475 of the packet forwarding device 400 receives the packet (at step S1001), the packet sorting processing section 410 of the packet forwarding device 400 determines whether the packet is addressed to the packet forwarding device 400 itself based on the address of the packet (at step S1002). If the packet is not addressed to the packet forwarding device 400 (“No” at step S1002), the packet transfer section 420 searches the routing table 445 (at step S1003) and determines whether the destination of the packet is present in the routing table 445 (at step S1004).

If the destination of the packet is not present in the routing table 445 (“No” at step S1004), the packet transfer section 420 notifies the sender that the packet cannot be repeated and discards the packet (at step S1005). If the destination of the packet is present in the routing table 445 (“Yes” at step S1004), the packet transfer section 420 changes the destination of a packet header and forwards the packet from the corresponding network I/F 475 of the packet forwarding device 400 (at step S1006).

If the packet is addressed to the packet forwarding device 400 (“Yes” at step S1002), the packet transfer section 420 searches the virtual communication path in the virtual communication path management table 435 based on the packet connection information, that is, the address and port number of the sender/address and port number of the destination (at step S1007). The sorting processing section 410 determines whether the virtual communication path is present (at step S1008).

If no virtual communication path is present (“No” at step S1008), the packet forwarding device 400 processes the packet as a received packet addressed to the packet forwarding device 400 (at step S1009). If the virtual communication path is present (“Yes” at step S1008), the sorting processing section 410 sorts the packet to the received packet transfer section 430 and the received packet transfer section 430 transfers the packet to the packet control device 200 using the virtual communication path (at step S1010). The transferred packet reception section 230 of the packet control device 200 receives the packet transferred from the packet forwarding device 400 (at step S1011). The transferred packet reception section 230 further transfers the packet to the routing section 210 that opens the socket corresponding to the virtual communication path.

As explained in the steps of procedures for receiving the packet and those for forwarding the packet, the packet forwarding device 400 transfers the routing information packet received at the network I/F 475 to the packet control device 200. The packet control device 200 receives the routing information packet which is transferred from the virtual I/F 215 which holds the address information made to associate with the network I/F 475 and the packet forwarding device 400, and transfers the packet to the routing section 210 while making the packet associate with the virtual I/F 215. The routing section 210 receives the routing information packet delivered while being made to associate with the virtual I/F 215 and transfers the packet to the packet forwarding device 400. Therefore, the routing section 210 can forward the packet, which the routing section 210 forwards to the virtual I/F 215, from the network I/F 475 and the packet received at the network I/F 475 of the packet forwarding device 400 can be processed as if the packet is received at the virtual I/F 215. Hence, it is possible to separate and cooperate the packet control device 200 and the packet forwarding device 400 from and with each other without modifying the conventionally used routing application.

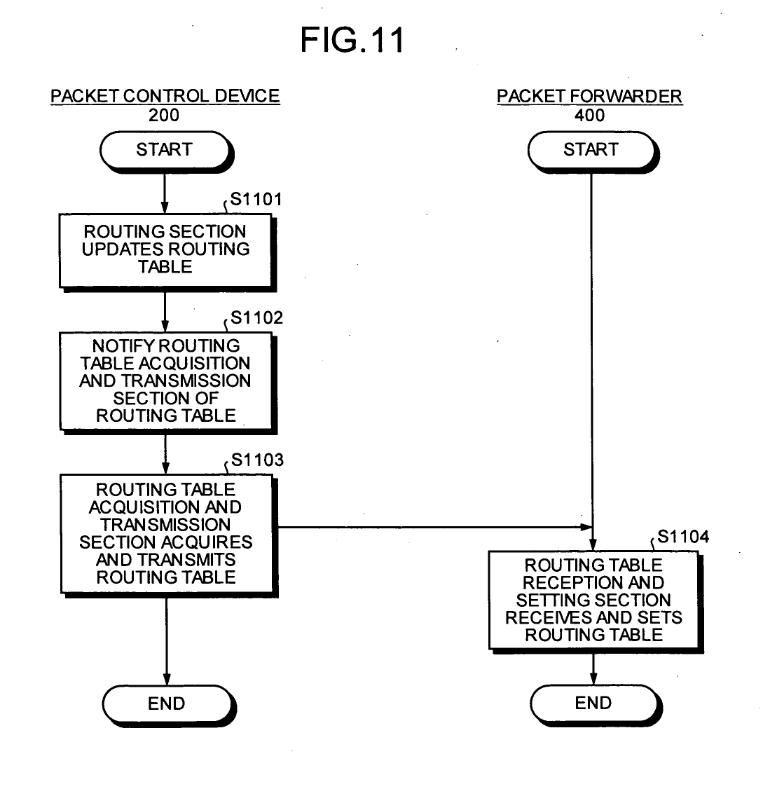

Steps of procedures for transferring the routing table of the packet control system shown in FIG. 2 will be explained. FIG. 11 is a flow chart illustrating steps of procedures for transferring the routing table of the packet control system shown in FIG. 2.

The routing section 210 of the packet control device 200 exchanges the routing information with the network nodes 495a to 495c and thereby updates the routing table 245 (at step S1101). If the routing section 210 notifies the routing table acquisition and transmission section 240 of the update of the routing table 245 (at step S1102), the routing table acquisition and transmission section 240 acquires the routing table 245 and transfers the routing table 245 to the packet forwarding device 400 (at step S1103). The routing table reception and setting section 440 of the packet forwarding device 400 receives the routing table 245 transferred from the packet control device 20 and updates the old routing table 445 (at step S1104). If the routing table 445 is updated, the entire routing table can be transmitted to the routing table reception and setting section 440 or a change in the routing table can be transmitted thereto as a difference.

As explained above, the packet control device 200 includes the routing table acquisition and transfer section 240 which acquires the routing table updated by the routing section 210 and which transfers the routing table to the packet forwarding device 400. Therefore, if the routing section 210 updates the routing table 245, the routing table acquisition and transfer section 240 can acquire the routing table 245 and transmit the routing table 245 to the packet forwarding device 400.

Further, the packet forwarding device 400 includes the routing table reception and setting section 440 which receives the routing table 245 transmitted by the routing table acquisition and transmission section 240 and which sets the routing table 445 to the packet forwarding device 400. Therefore, the packet forwarding device 400 can transmit and receive the packet using the network I/F 475 based on the latest routing table 245.

In the first embodiment, the example in which the packet control system according to the present invention is applied to the router which is separated into the packet control device and the packet forwarding device has been explained. In a second embodiment, the example in which the router separated into the packet control device and the packet forwarder is applied to the network will be explained. Examples of grouping virtual I/F's if the packet control device controls a plurality of packet forwarders, in particular, will be explained herein.

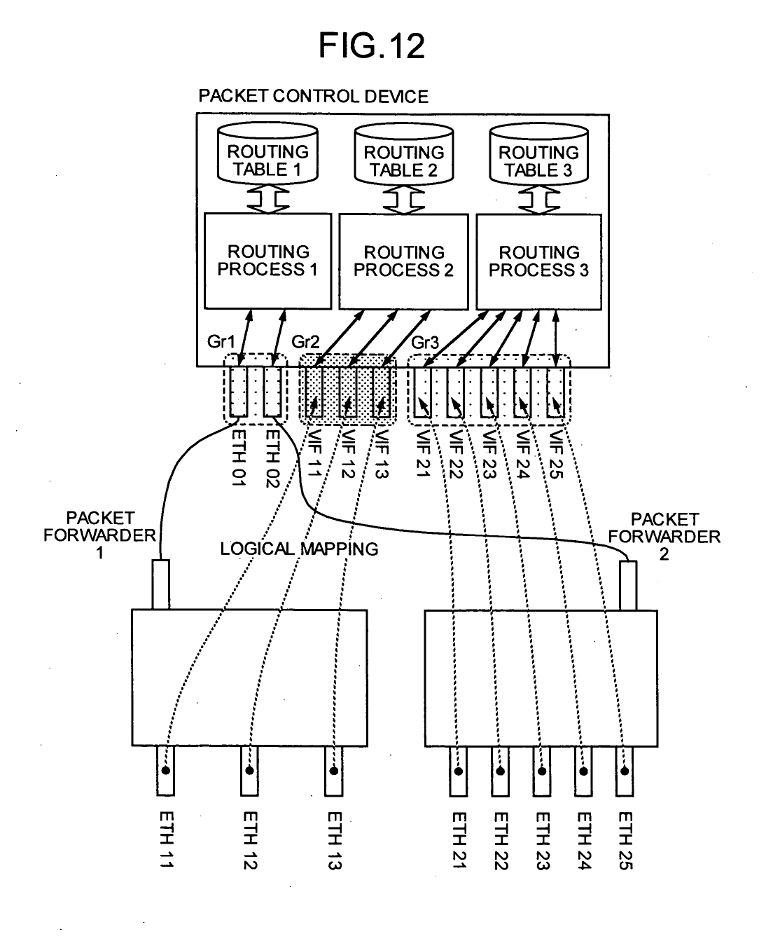

FIG. 12 illustrates the concept of grouping the virtual I/F's of the packet control system in the second embodiment of the present invention. As shown in FIG. 12, the packet control device controls a packet forwarder 1 and a packet forwarder 2. The packet control device holds actual I/F's, i.e., ETH01 and EHT02 of the packet forwarder 1 and the packet forwarder 2 which are connected to each other by solid lines. These I/F's are grouped into a group Gr1. In addition, virtual I/F's VI/F11, VI/F12, and VI/F13 corresponding to actual I/F's, that is, ETH11, ETH12, and ETH13 of the packet forwarder 1 are grouped into a group Gr2. Likewise, virtual I/F's VI/F21, VI/F22, VI/F23, V1/F24, and VI/F25 corresponding to actual I/F's, that is, ETH21, ETH22, ETH23, ETH24, and ETH25 of the packet forwarder 2 are grouped into a group Gr3.

The packet control device makes routing processing sections 1 to 3 associate with the groups Gr1 of the actual I/F's, and the groups Gr2 and Gr3 of the virtual I/F's, respectively. As explained in the first embodiment, the routing processing sections 1 to 3 generate routing tables 1 to 3 independently of one another.

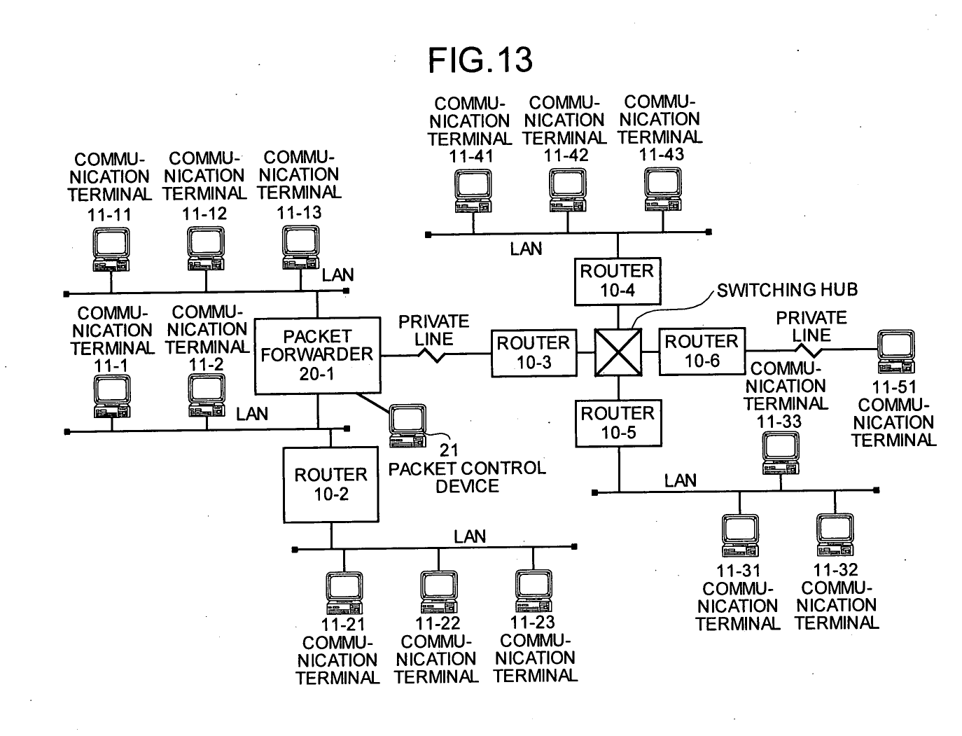

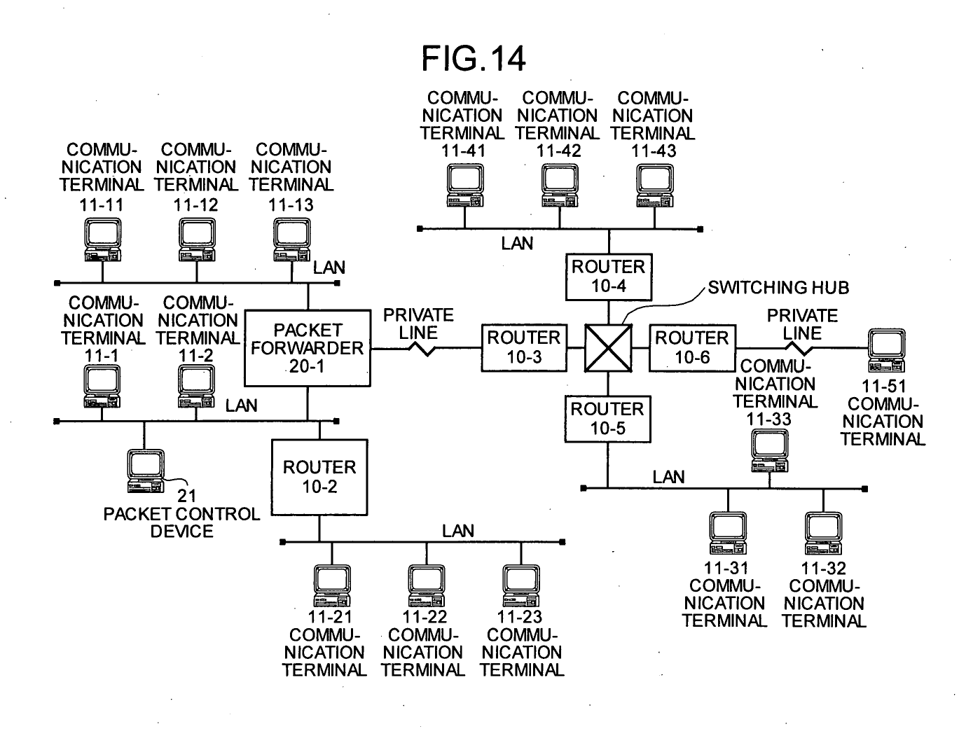

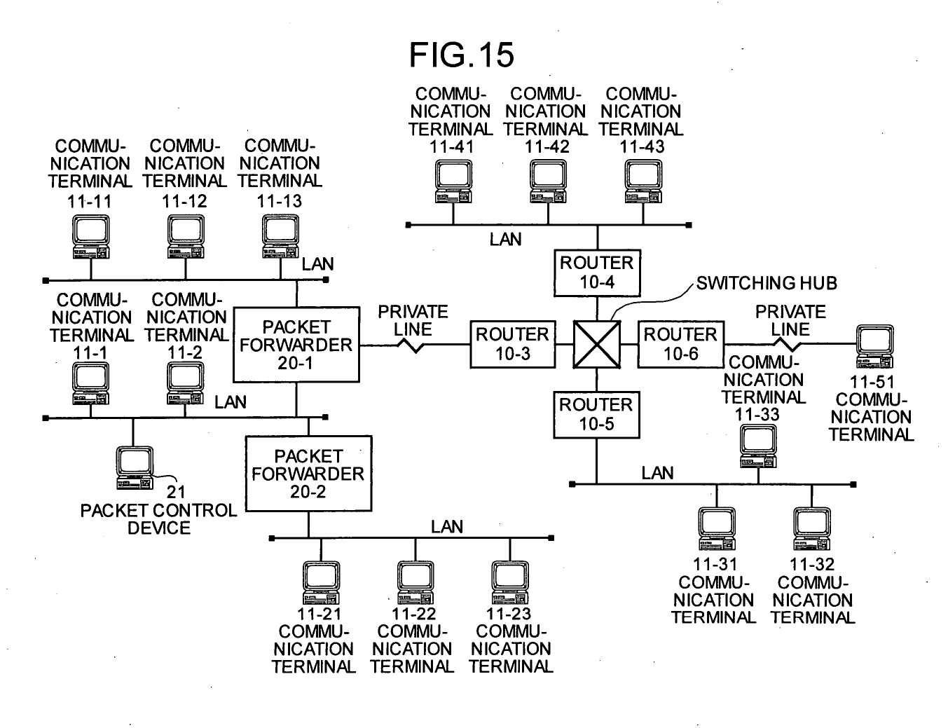

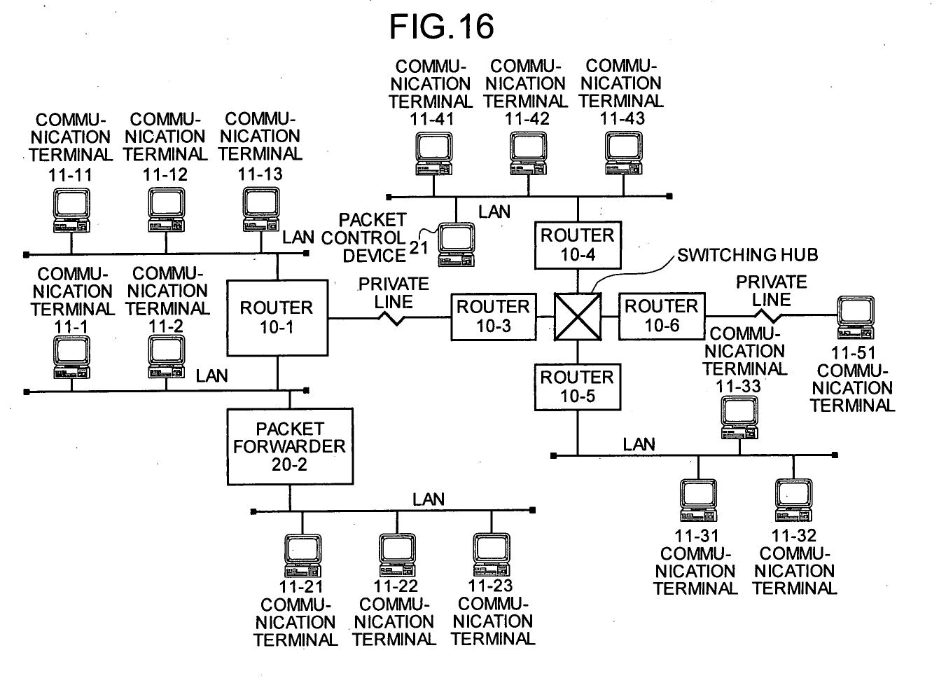

An example of the network to which the packet control system shown in FIG. 12 is applied will be explained next. FIG. 13 illustrates one example of the configuration of the network to which the packet control system shown in FIG. 12 is applied. FIG. 14 illustrates another example of the configuration of the network to which the packet control system shown in FIG. 12 is applied. FIG. 15 illustrates still another example of the configuration of the network to which the packet control system shown in FIG. 12 is applied. FIG. 16 illustrates still another example of the configuration of the network to which the packet control system shown in FIG. 12 is applied.

In the packet control system shown in FIG. 13, a packet control device 21 controls a packet forwarder 20-1 through a dedicated line. This example is the closest to the first embodiment. In the packet control system shown in FIG. 14, the packet control device 21 controls the packet forwarder 20-1, and the packet control device 21 and the packet forwarder 20-1 are connected to each other through a LAN. In the packet control system shown in FIG. 15, the packet control device 21 controls packet forwarders 20-1 and 20-2 through LAN's.

In the packet control system shown in FIG. 16, the packet control device 21 controls a packet forwarder 20-2. In FIG. 16, the packet control device 21 and the packet forwarder 20-2 are not directly connected to each other but can communicate with each other through a plurality of LAN's, dedicated lines and packet forwarders or through a plurality of LAN's, dedicated lines or packet forwarders provided midway. In the example of FIG. 16, it is necessary not to disconnect the virtual communication path by routers 10-4, 10-3, and 10-1 provided between or midway along the packet control device 21 and the packet forwarder 20-2 depending on the result of routing. Specifically, it is necessary to set static virtual communication paths to the routers 10-4, 10-3, and 10-1 provided between or midway along the packet control device 21 and the packet forwarder 20-2. Namely, it is necessary to group the virtual I/F's corresponding to the actual I/F's of the routers 10-4, 10-3, and 10-1 and route the packet using the routing processing sections for the respective groups.

As can be seen, the virtual I/F's corresponding to the network I/F's of the packet forwarders and the I/F's of the packet control device are grouped, and the packet control device routes the packet using the routing processing sections for the respective groups. It is, therefore, possible to separate and cooperate forwarding functions and control functions of the routers without modifying the conventionally used routing application.

Further, if a plurality of packet forwarders are connected to the packet control device, the virtual I/F's corresponding to the network I/F's of the respective packet forwarders are grouped and the packet control device routes the packet using the routing processing sections for the respective groups. Therefore, the packet control device can control a plurality of packet forwarders and the forwarding functions and the control functions of the routers can be separated and cooperated without modifying the conventionally used routing application.

In a third embodiment, the example of applying the router control device according to the present invention to the router control system will be explained. The outline and features of the router control device in the third embodiment will be explained first, the configuration of the router control system will be explained next, and various processing procedures including steps of procedures for setting the virtual interface of this router control system, those for transferring a received and transmitted packet, and those for setting the routing table thereof will finally be explained.

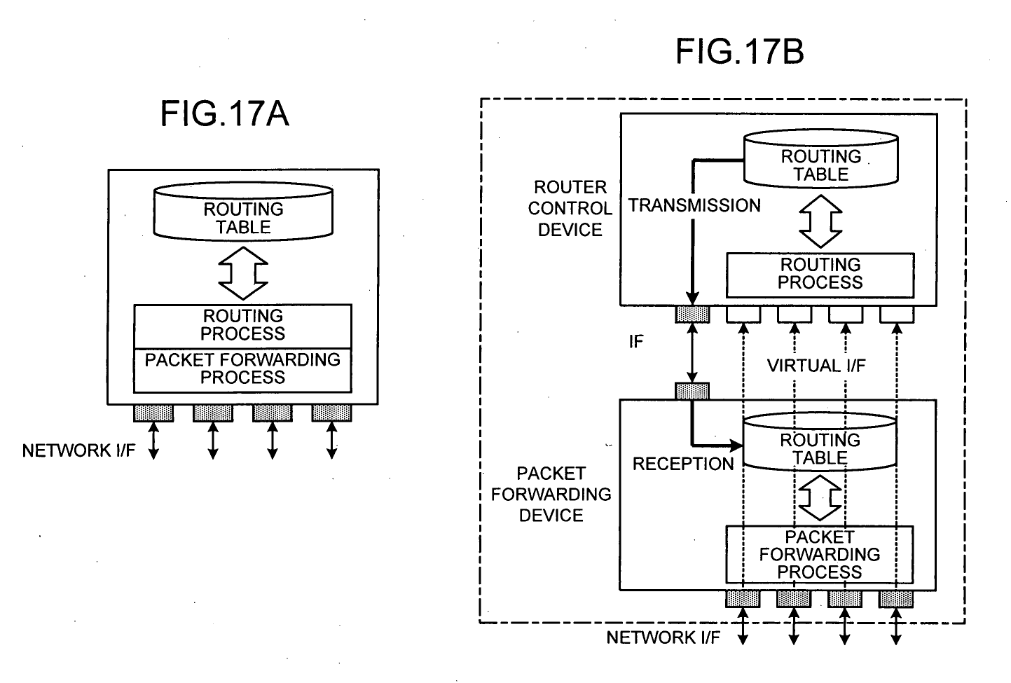

The concept of the router in the third embodiment will first be explained. FIG. 17A illustrates the concept of a conventional router, and FIG. 17B illustrates the concept of the router in the third embodiment of the present invention.

Generally, as shown in FIG. 17B, according to the router control device that constitutes the router according to the present invention, the router control device shares the control function with the router while functions of the conventional router are separated into the control function and the forwarding function and in that the router control device is compatible with at least a conventionally used routing protocol software.

Specifically, according to the router control device, the network I/F of the forwarder is set on the router control device as a virtual I/F, the router control device holds the routing information on the virtual I/F based on routing information on the routing information packet among data packets received at the network interface, controls the routing information packet to be delivered from the network I/F, calculates the path based on the routing information and the virtual I/F information, generates the routing table per forwarder, and controls the forwarder to transfer the data packet based on the routing table. Therefore, even if the functions of the conventional router are separated into the control function and the forwarding function, it is unnecessary to develop a new routing protocol software because the router control device is compatible with the conventionally used routing protocol software.

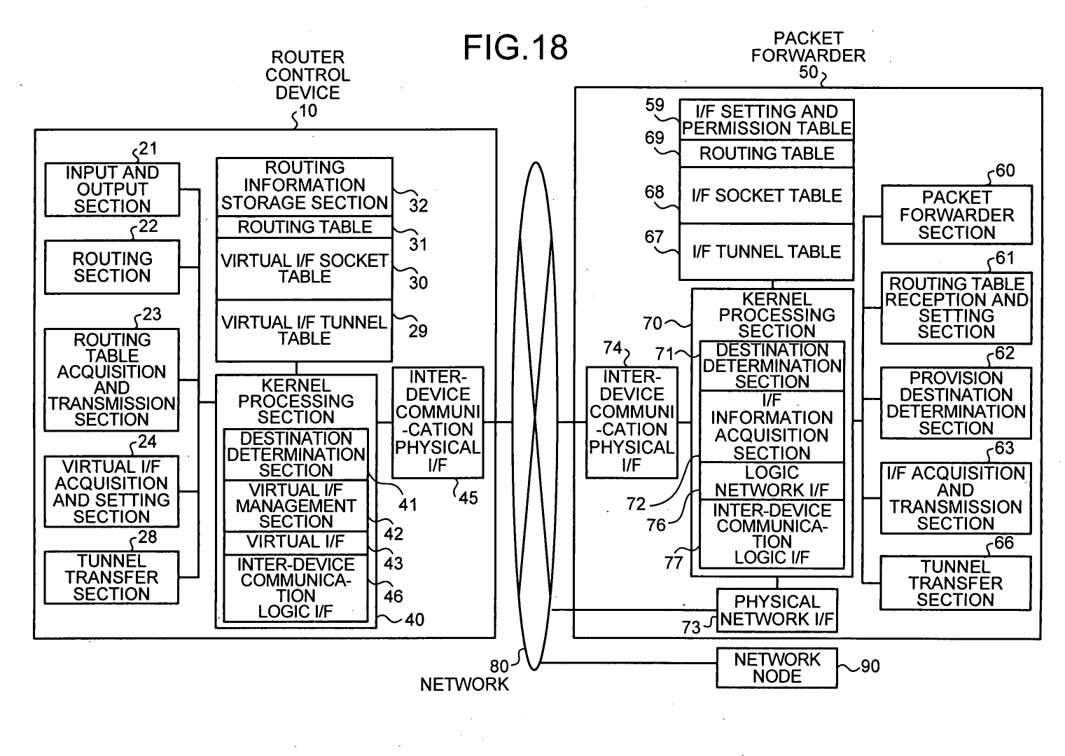

The configuration of the router control system in the third embodiment will be explained with reference to a functional block diagram of FIG. 18. FIG. 18 is the functional block diagram of the configuration of the router control system in the third embodiment. As shown in FIG. 18, the router control system consists of a control device 10, a forwarder 50, a network 80, and a network node 90.

The network 80 is a network for holding data communication according to a communication protocol of a data link layer or higher layers and may be one of a dedicated line, a LAN or the Internet. Normally, the router routes the packet and transfers the packet according to the communication protocol of a network layer. The network node 90 is a router connected to the network 80. In the third embodiment, the network node 90 is a device with which the router control device 10 communicates routing information through the forwarder 50 or a device which transmits and receives data repeated by the router 50.

The router control device 10, which shares the control function with the router, consists of an input and output section 21, a routing section 22, a routing table acquisition and transmission section 23, a virtual I/F acquisition and setting section 24, a tunnel transfer section 28, a virtual I/F tunnel table 29, a virtual I/F socket table 30, a routing table 31, a routing information storage section 32, a kernel processing section 40, and an inter-device communication physical I/F 45. The I/F is an abbreviation of the interface and is a generic term of a logic I/F and a physical I/F unless specified otherwise. Further, while the logic I/F normally corresponds to the physical I/F one by one, a plurality of logic I/F's may correspond to one physical I/F.

The input and output section 21 is an input and output device which inputs a user's command and which outputs operation states of the router control device 10 and the forwarder 50, a response to command, and the like. Specifically, the input and output section 21 is a display device such as a keyboard, a mouse, a cathode ray tube (CRT) or a liquid crystal display, or a printer.

The routing section 22 is a processing section which generates the routing table 31 for a virtual I/F 43 based on routing information on the data packet received at the network I/F per forwarder 50 and which controls the forwarder 50 to transfer the data packet based on the routing table 31. Specifically, the routing section 22 acquires the routing information from the network node 90 according to a routing protocol such as the RIP or the OSPF, calculates the path based on the routing information, and generates the routing table 31.

The routing table acquisition and transmission section 23 is a processing section which acquires the routing table 31 generated by the routing section 22 and which transmits the routing table 31 to the forwarder 50. Specifically, if the routing section 22 notifies the kernel processing section 40 of the forwarder 50 of the update of the routing table 31, then the kernel processing section 40 notifies the routing table acquisition and transmission section 23 of the router control device 10 of the update of the routing table 31, and the routing table acquisition and transmission section 23 acquires the routing table 31 and transmits the routing table 31 to the forwarder 50 through the I/F 45.

The virtual I/F reception and setting section 24 is a processing section which receives a virtual I/F setting command from the user and which sets a virtual I/F 43 corresponding to a logic network I/F 76 of the forwarder 50 on the router control device 10.

The tunnel transfer section 28 is a processing section which tunnel-transfers the data packet based on the communication path that connects the virtual I/F 43 to the logic network I/F 76. Specifically, the tunnel transfer section 28 adds a tunnel identifier to the data packet received from the virtual I/F 43 based on the virtual I/F tunnel table 29 and the virtual I/F socket table 30 and transmits the tunnel identifier-added data packet to the forwarder 50, and eliminates the tunnel identifier of the data packet received from the forwarder 50 and transfers the resultant data packet to the virtual I/F 43.

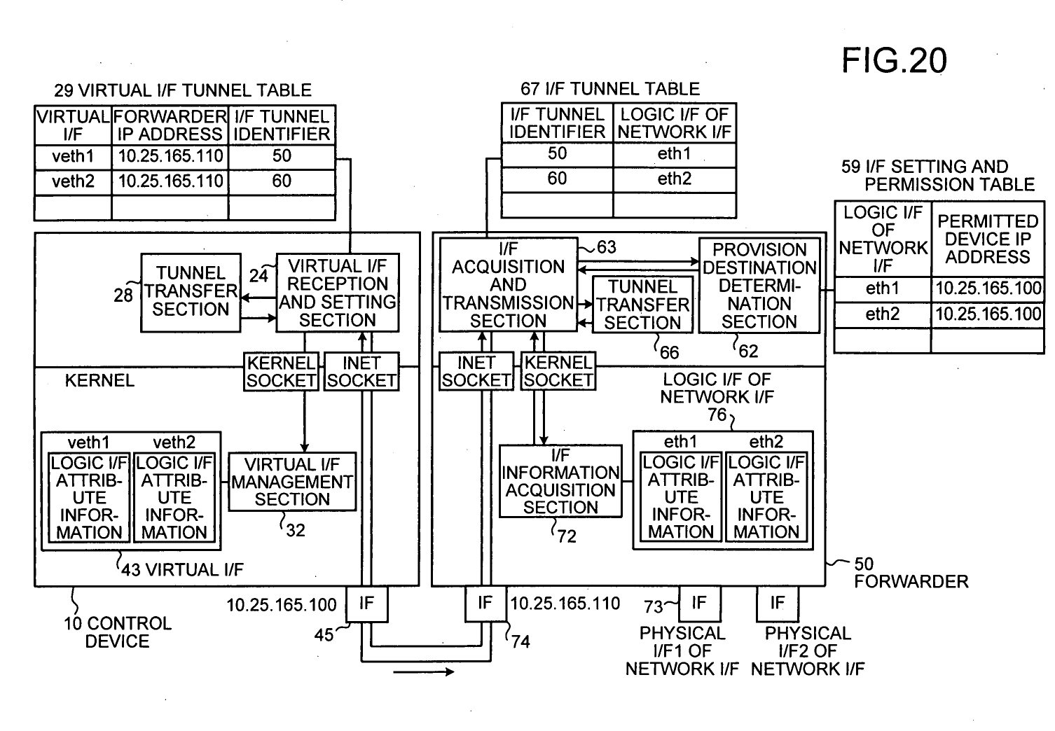

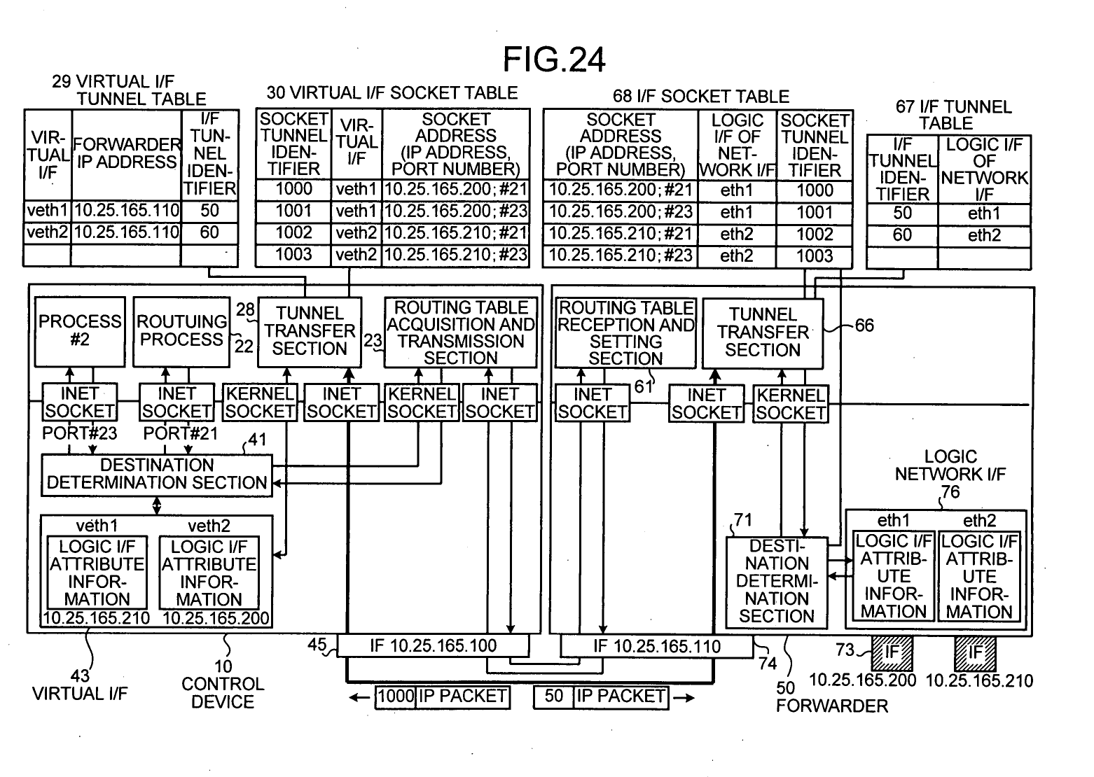

The tunnel identifier includes a socket tunnel identifier and an I/F tunnel identifier (see FIGS. 20 and 24). The socket tunnel identifier is a tunnel identifier of the communication path which connects the router control device 10 to the forwarder 50 for each communication connection. Specifically, the socket tunnel identifier identifies the communication path for transferring the data packet received by the forwarder 50 to the router control device 10. The I/F tunnel identifier is a tunnel identifier of the communication path which connects the router control device 10 to the forwarder 50 for each network I/F. Specifically, the I/F tunnel identifier identifies the communication path for transferring the data packet forwarded from the router control device 10 to the forwarder 50.

The virtual I/F tunnel table 29 is a table which decides on the communication path through which the data packet forwarded from the routing section 22 is passed when the data packet is transferred from the router control device 10 to the forwarder 50. Specifically, the virtual I/F tunnel table 29 is a table which makes the virtual I/F 43 associate with an IP address of the forwarder/the tunnel identifier. The virtual I/F socket table 30 is a table which decides on the virtual I/F 43 at which the router control device 10 receives the data packet from the communication path through which the data packet received by the forwarder 50 is passed when the data packet is transferred from the forwarder 50 in a direction of the virtual I/F 43. Specifically, the virtual I/F socket table 30 is a table which makes the tunnel identifier associate with the virtual I/F 43/a socket address (an IP address port+a port number) of the routing section 22.

The routing table 31 is a table which makes an IP address of the destination of the data packet associate with an IP address of a next transfer destination. In other words, the routing table 31 is a table which defines the communication path to the destination of the data packet obtained as a result of the routing exerted by the routing section 22. The routing information storage section 32 is a storage section which stores the routing table 31 and the routing information on the virtual I/F based on the routing information on the routed packet received at the network I/F.

The kernel processing section 40, which is a core of the operating system (OS), is a processing section which performs file management, memory management, process execution control, and the like. Specifically, the kernel processing section 40 includes at least a destination determination section 41, a virtual I/F management section 42, the virtual I/F 43, and an inter-device communication logic I/F 46. If the socket is opened for the kernel processing section 40, the destination determination section 41 notifies the routing table acquisition and transmission section 23 of the opening of the socket.

The virtual I/F management section 42 is a processing section which manages the virtual I/F 43. The virtual I/F 43 is a logic I/F obtained by acquiring the network I/F of the forwarder 50 by the virtual I/F reception and setting section 24 and setting the network I/F as the virtual I/F on the router control device 10.

The inter-device communication physical I/F 45 is a physical I/F used when the router control device 10 communicates data with the forwarder 50 through the network 80. The inter-device communication logic I/F 46 is a logic I/F used when the router control device 10 communicates the data packet with the forwarder 50 through the network 80. Specifically, the I/F 46 is a communication I/F such as an Ethernet® 10BASE-T or RS-232C that includes a device driver.

The forwarder 50 is a device that shares the forwarding function with the router. The forwarder 50 consists of a data forwarder section 60, a routing table reception and setting section 61, a provision destination determination section 62, an I/F acquisition and transmission section 63, a tunnel transfer section 66, an I/F setting and permission table 59, an I/F tunnel table 67, an I/F socket table 68, a routing table 69, a kernel processing section 70, a physical network I/F 73, and an inter-device communication physical I/F 74.

The data forwarder section 60 is a processing section which transmits the data packet received by the transfer section 50 to the I/F 73 with the network node 90. Specifically, if a destination determination section 71 of the kernel processing section 70 determines that the data packet is to be transferred to the other device based on the header of the data packet, the kernel processing section 70 notifies the data forwarder section 60 of the determination result and the data forwarder section 60 forwards the data packet to the next destination based on the routing table 69.

The routing table reception and setting section 61 is a processing section which receives the routing table 31 transmitted from the routing table acquisition and transmission section 23 of the router control device 10 and which sets the routing table 31 as the routing table 69 to the forwarder 50. The provision destination determination section 62 is a processing section which determines whether to permit the setting of the virtual I/F corresponding to the logic network I/F 76 based on the I/F setting permission table 59 if the virtual I/F acquisition and setting section 24 of the router control device 10 issues a request to set the logic network I/F 76. The I/F acquisition and transmission section 63 is a processing section which acquires the logic I/F from the logic network I/F 76 managed by an I/F information acquisition section 72 of the kernel processing section 70, and which transmits the acquired logic I/F to the virtual I/F acquisition and setting section 24 of the router control device 10.

The tunnel transfer section 66 tunnel-transfers the data packet based on the communication path that connects the virtual I/F 43 to the logic network I/F 76. Specifically, the tunnel transfer section 66 adds the tunnel identifier to the data packet received from the logic network I/F 76 based on the I/F tunnel table 67 and the I/F socket table 68 and forwards the data packet to the router control device 10, and eliminates the tunnel identifier from the data packet received from the router control device 10 and transfers the data packet to the logic network I/F 76.

The I/F tunnel table 67 is a table which defines the communication path through which the data packet is passed when the data packet is transferred from the router control device 10 to the forwarder 50. Specifically, the I/F tunnel table 67 is a table which makes the logic network I/F 76 associate with the tunnel identifier. The I/F socket table 68 is a table which defines the communication path through which the data packet received at the physical network I/F 73 is passed when the data packet is transferred from the forwarder 50 to the router control device 10. Specifically, the I/F socket table 68 is a table which makes the logic network I/F 76/the socket address associate with the tunnel identifier.

The routing table 69 is a table set by the routing table reception and setting section 61 based on the routing table 31 received from the routing table acquisition and transmission section 23 of the router control device 10. Specifically, the routing table 69 is a table which makes the IP address of the destination of the data packet associate with the IP address of the next destination. The I/F setting and permission table 59 is a table which sets a provision destination to which the logic network I/F 76 of the forwarder 50 is provided in advance. Specifically, the I/F setting and permission table 59 is a table which makes the logic network I/F 76 associate with the IP address of the permitted device.

The kernel processing section 70, which is a core of the OS, is a processing section which performs the file management, the memory management, the process execution and control, and the like. Specifically, the kernel processing section 70 includes at least a destination determination section 71, an I/F information acquisition section 72, and a logic network I/F 76. The destination determination section 71 is a processing section which determines the destination of the data packet based on the header of the data packet and which notifies the relevant processing sections of the destination if necessary. Specifically, the destination determination section 71 acquires the IP address from the IP header of the data packet, reads a destination port number from a TCP header, and determines the destination of the data packet. If determining, for example, that the data is a data packet transferred from the destination to the network node, the destination determination section 71 notifies the data forwarder section 60 of the determination result.

The I/F information acquisition section 72 is a processing section which manages the logic network I/F 73. The logic network I/F 76 is a logic I/F used when the forwarder 50 communicates with the network node 90 on the network 80.

The physical network I/F 73 is a physical I/F of the network I/F used when the forwarder 50 communicates with the network node 90 on the network 80. The inter-device communication I/F 74 is an I/F used when the forwarder 50 communicates the data packet with the router control device 10 through the network 80. Specifically, the inter-device communication I/F 74 is a communication I/F such as the Ethernet® 10BASE-T or RS-232C including the device driver.

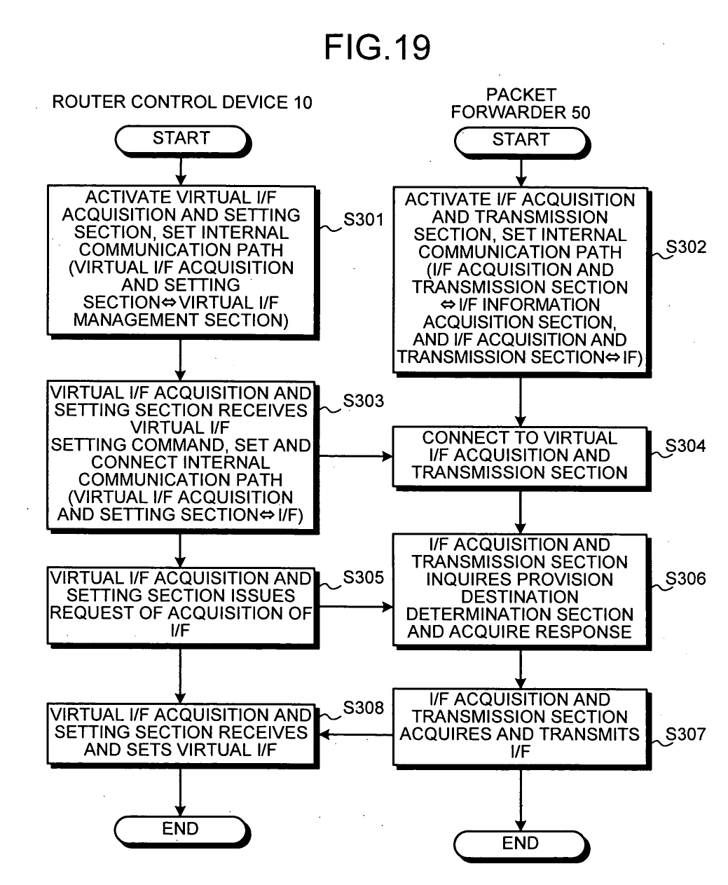

Steps of procedures for setting the virtual I/F of the router control system shown in FIG. 18 will be explained next. FIG. 19 is a flow chart of the steps of procedures for setting the virtual I/F of the router control system shown in FIG. 18. The virtual I/F is set when the router control system is activated or when a new network I/F is set.

Initially, simultaneously with the activation of the router control device 10, the virtual I/F acquisition and setting section 24 is activated. Synchronously with the activation of the virtual I/F acquisition and setting section 24, the communication path (the virtual I/F acquisition and setting section 24⇄the virtual I/F management section 42) is generated (at step S301).

Likewise, simultaneously with the activation of the forwarder 50, the I/F transmission and acquisition section 63 is activated. Synchronously with the activation of the I/F transmission and acquisition section 63, communication paths (the I/F acquisition and transmission section 63⇄the I/F information acquisition section 72, and the I/F acquisition and transmission section 63⇄the I/F 74) are generated (at step S302).

The virtual I/F acquisition and setting section 24 receives a virtual I/F setting command, sets the communication path (the virtual I/F acquisition and setting section 24⇄the I/F 45), and starts communicating with the I/F acquisition and transmission section 63 of the forwarder 50 (at step S303).

The router control device 10 issues a request of the acquisition of the logic network I/F 76 of the forwarder 50 to the forwarder 50 (at step S305). The I/F acquisition and transmission section 63 of the forwarder 50 which receives the request of the acquisition of the logic network I/F 76 inquires the provision destination determination section. 62 whether to transmit the logic network I/F 76 to the router control device 10. The provision destination determination section 62 determines whether to provide the logic network I/F 76 based on the preset I/F setting and permission table 59 and transmits a response to the l/F acquisition and transmission section 63 (at step S306).

The I/F acquisition and transmission section 63 transmits the logic network I/F 76 to the virtual I/F acquisition and setting section 24 of the router control device 10 based on the response (at step S307). The virtual I/F acquisition and setting section 24 transfers the acquired logic network I/F 76 to the virtual I/F management section 42 of the kernel processing section 42, sets the virtual I/F 43, and sets the communication path (the destination determination section 41<the virtual I/F 43) (at step S308).

One example of the communication paths generated at the steps of procedures for setting the virtual I/F of the router control system will be concretely explained. FIG. 20 illustrates one example of the communication paths generated at the steps of procedures for setting the virtual I/F of the router control system shown in FIG. 18. As shown in FIG. 20, at the steps of procedures for setting the virtual I/F, the virtual I/F acquisition and setting section 24 and the I/F acquisition and transmission section 63 connect the logic network I/F on the forwarder 50 to the virtual I/F 43 on the router control device 10 by the communication path, thereby setting the virtual I/F 43.

The virtual I/F acquisition and setting section 24 and the I/F acquisition and transmission section 63 notify the tunnel transfer sections 28 and 66 of the virtual tunnel table 29 and the I/F tunnel table 67, respectively. The virtual tunnel table 29 and the I/F tunnel table 67 are tables which define the communication path through which the data packet forwarded from the routing section 22 is passed when the data packet is transferred from the router control device 10 to the forwarder 50. Specifically, the virtual tunnel table 29 is a table which makes the virtual I/F associate with the forwarder IP address/the tunnel identifier. The I/F tunnel table 67 is a table which makes the logic network I/F associate with the tunnel identifier.

These tables are either set by the user or generated by a virtual I/F tunnel table generation section and a virtual I/F socket table generation section of the router control device 10 and an I/F tunnel table generation section of the forwarder 50, respectively although the virtual I/F tunnel table generation section, the virtual I/F socket table generation section, and the I/F tunnel table generation section are not shown in the functional block diagram of FIG. 18. The I/F setting and permission table 59 is set by the user in advance.

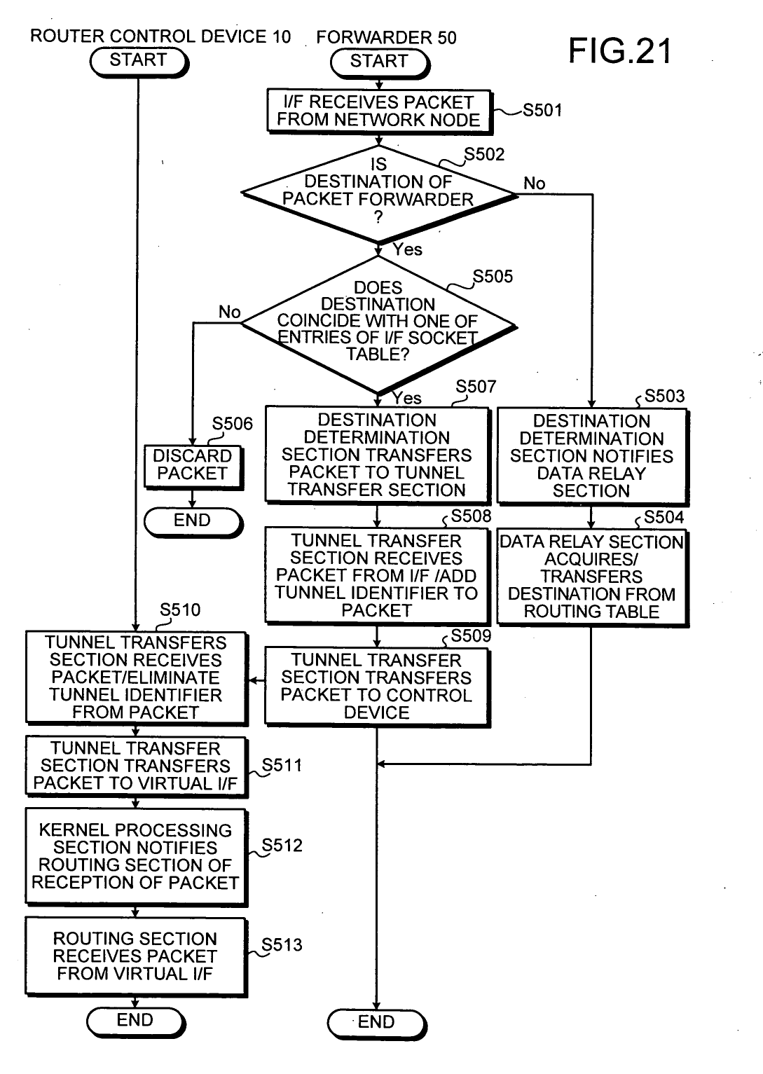

Steps of procedures for transferring the received packet of the router control system shown in FIG. 18 will be explained. FIG. 21 is a flow chart of the steps of procedures for transferring the received packet of the router control system shown in FIG. 18.

As shown in FIG. 21, if the physical network I/F 73 of the forwarder 50 receives the data packet from the network node 90 on the network 80 (at step S501), the destination determination section 71 determines the destination of the data packet based on the header of the data packet and determines whether the data packet is to be transferred to the forwarder 50 (at step S502). If determining that the destination of the data packet is not the forwarder 50 (“No” at step S502), then the destination determination section 71 notifies the data forwarder section 60 of the determination result, and the data forwarder section 60 acquires the transfer destination of the data packet from the routing table 69 and transfers the data packet to the destination (at steps S503 to S504).

If the destination of the data packet is the forwarder 50 (“Yes” at step S502), the destination determination section 71 determines whether the destination coincides with one of entries of the I/F socket table 68 while referring to the I/F socket table 68 (at step S505). If the destination does not coincide with any entry of the I/F socket table 68 (the destination does not coincide with the port number of the socket opened by the routing section 22 in this embodiment) (“No” at step S505), the destination determination section 71 discards the data packet (at step S506). If the destination coincides with any one of the entries of the I/F socket table 68 (“Yes” at step S505), the destination determination section 71 notifies the tunnel transfer section 66 of the reception of the data packet (at step S507).

The tunnel transfer section 66 receives the data packet from the logic network I/F 76, adds the tunnel identifier to the data packet based on the I/F socket table 68, and thereby encapsulates the data packet (at step S508). Further, the tunnel transfer section 66 transfers this data packet to the tunnel transfer section 28 of the router control device 10 (at step S509).

After receiving the data packet, the tunnel transfer section 28 of the router control device 10 eliminates the tunnel identifier from the data packet (at step S510) and transfers the data packet to the virtual I/F 43 based on the tunnel identifier and the virtual I/F socket table 30 (at step S511). If the virtual I/F 43 receives the data packet, the kernel processing section 40 reads the port number from the header of the data packet and notifies the routing section 22 of the arrival of the data packet (at step S512). The routing section 22 receives the data packet from the virtual I/F 43 (at step S513).

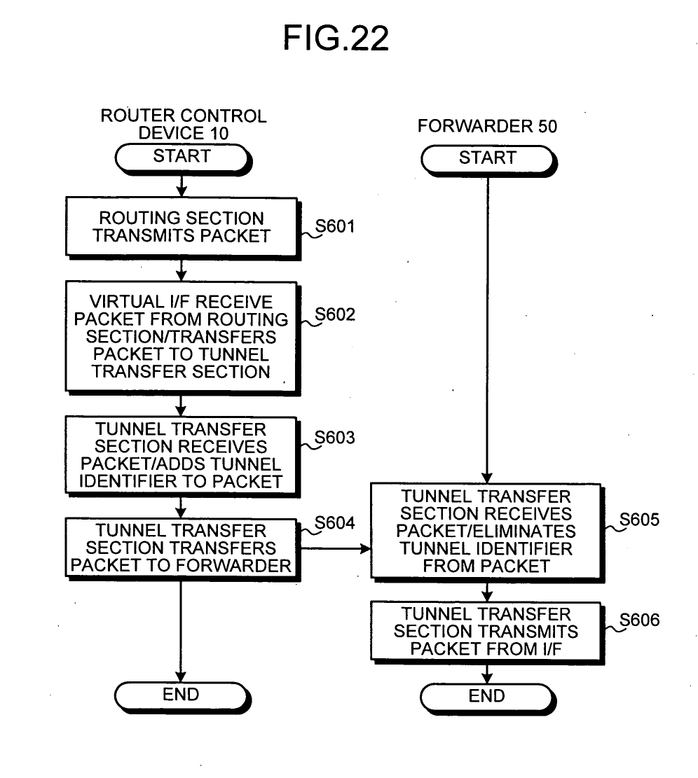

Steps of procedures for forwarding the forwarded packet of the router control system shown in FIG. 18 will be explained. FIG. 22 is a flow chart of the steps of procedures for transferring the forwarded packet of the router control system shown in FIG. 18.

As shown in FIG. 22, if the routing section 22 forwards the data packet to the virtual I/F 43 (at step S601), the virtual I/F 43 receives the data packet and notifies the tunnel transfer section 28 of the reception of the data packet (at step S602).

The tunnel transfer section 28 receives the data packet from the virtual I/F 43, adds the tunnel identifier to the data packet based on the virtual I/F tunnel table 29, and thereby encapsulates the data packet (at step S603). The tunnel transfer section 28 transfers the encapsulated data packet to the tunnel transfer section 66 of the forwarder 50 (at step S604). The tunnel transfer section 66 of the forwarder 50 receives the data packet and eliminates the tunnel identifier from the data packet (at step S605). The tunnel transfer section 66 also forwards the data packet from the physical network I/F 73 (at step S606).

As can be seen, the control device 10 receives the logic network I/F of the forwarder 50 from the forwarder 50, sets the I/F as the virtual I/F 43 on the router control device 10, generates the routing table 31 for the virtual I/F 43 per forwarder 50 based on the routing information on the data packet received at the network I/F, and controls the forwarder 50 to transfer the data packet based on the routing table 31. Therefore, it is possible to provide the router control system compatible with the conventionally used routing protocol software.

Further, the router control device 10 tunnel-transfers the data packet based on the communication path that connects the virtual I/F 43 to the logic network I/F 76, generates the routing table 31 for the virtual I/F 43 per forwarder 50 based on the routing information on the data packet thus tunnel-transferred, and controls the forwarder 50 to transfer the data packet based on the routing table 31. Therefore, it is possible to provide the router control system compatible with the conventionally used routing protocol software.

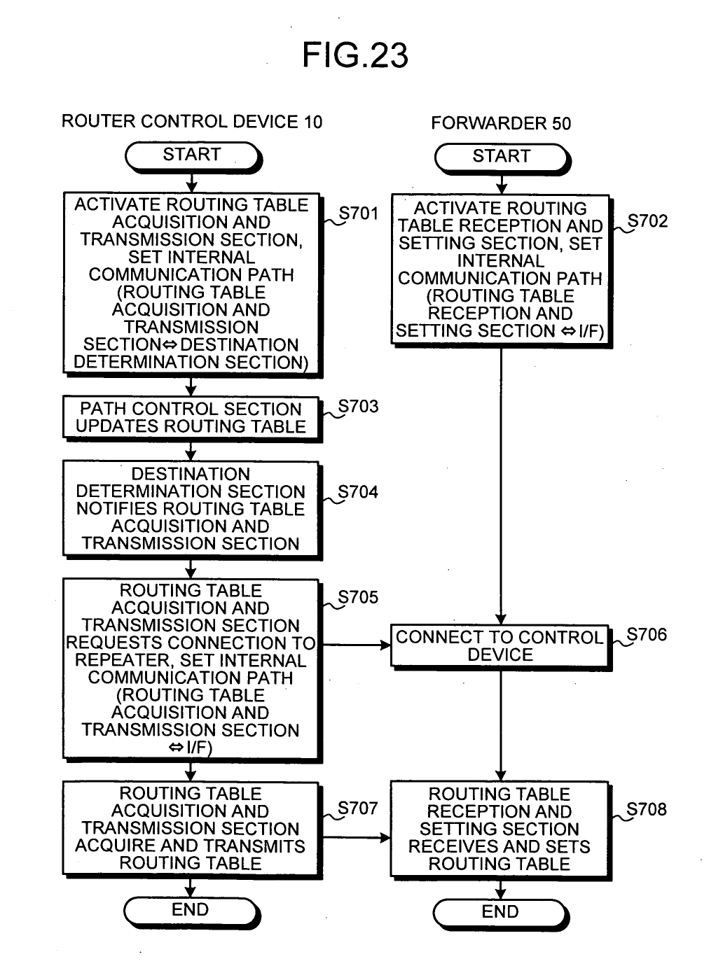

Steps of procedures for setting the routing tables of the router control system shown in FIG. 18 will be explained. FIG. 23 is a flow chart of the steps of procedures for setting the routing tables of the router control system shown in FIG. 18. The routing tables are set when the routing section 22 updates the routing table based on the routing information.

Initially, simultaneously with the activation of the router control device 10, the routing table acquisition and transmission section 23 is activated. Synchronously with the activation of the routing table acquisition and transmission section 23, the communication path (the routing table acquisition and transmission section 23⇄the destination determination section 71) is generated (at step S302).

Likewise, simultaneously with the activation of the forwarder 50, the routing table reception and setting section 61 is activated. Synchronously with the activation of the routing table reception and setting section 61, the communication path (the routing table reception and setting section 61⇄the I/F 74) is generated.

If the routing section 22 updates the routing table 31 based on the routing information, the routing section 22 notifies the destination determination section 41 of the update of the routing table 31 (at step S703). If the destination determination section 41 notifies the routing table acquisition and transmission section 23 of the update (at step S704), the routing table acquisition and transmission section 23 generates the communication path (the routing table acquisition and transmission section 23⇄the I/F 45) and requests connection to the forwarder 50 (at step S705). In response to the connection request of the routing table acquisition and transmission section 23, the routing table reception and setting section 61 of the forwarder 50 connects the forwarder 50 to the router control device 10 (at step S706).

If the routing table acquisition and transmission section 23 acquires the routing table 31 and transmits the routing table 31 to the forwarder 50 (at step S707), the routing table reception and setting section 61 receives the routing table 31 and updates the routing table 69 (at step S708).

One example of the communication paths generated at the steps of procedures for transferring the received and transmitted packet and those for setting the routing tables of the router control system shown in FIG. 18 will be explained. FIG. 24 illustrates one example of the communication paths generated at the steps of procedures for transferring the received and transmitted packet and those for setting the routing tables of the router control system shown in FIG. 18.

As shown in FIG. 24, the tunnel transfer sections 28 and 66 transfer the data packet based on the communication path that connects the virtual I/F 43 to the logic network I/F 76. Specifically, by tunnel-transferring the data packet received at the network I/F of the forwarder 50 to the virtual I/F 43, and transferring the data packet forwarded by the routing section 22 from the virtual I/F 43 to the logic network I/F 76, the communication with the network node 90 on the network can be established.

If the data packet transfer is routinely performed between the route control section 22 and the virtual I/F 43 and between the network I/F 73 and the tunnel transfer section 66, the data packet is passed through the destination determination section 41 without being subjected to determination. On the other hand, as for the data packet received at the network I/F, the destination determination section 41 determines whether the data packet is to be transferred to the control device 10 or to be transferred to the network node 90. The data packet forwarded from the routing section 22 is passed through the destination determination section 71 without being subjected to the determination and transmitted from the network I/F.

As can be seen, the router control device 10 receives the logic network I/F 73 from the forwarder 50, sets the I/F as the virtual I/F 43 on the router control device 10, tunnel-transfers the data packet based on the communication path that connects the virtual I/F 43 to the physical network I/F 76, generates the routing table 30 for the virtual I/F 43 based on the routing information on the data packet thus tunnel-transferred per forwarder 50, acquires the routing table 31, and transmits the routing table 31 to the forwarder 50. The forwarder 50 transfers the data packet based on the routing table 31. Therefore, it is possible to provide the router control system compatible with the conventionally used routing protocol software.

The router control device and the router control method explained in the third embodiment can be realized by allowing a computer system such as a personal computer or a workstation to execute a program prepared in advance. In a fourth embodiment, therefore, the computer system which executes a router control program that has the same functions as those of the router control device (or the router control method) explained in the third embodiment will be explained.

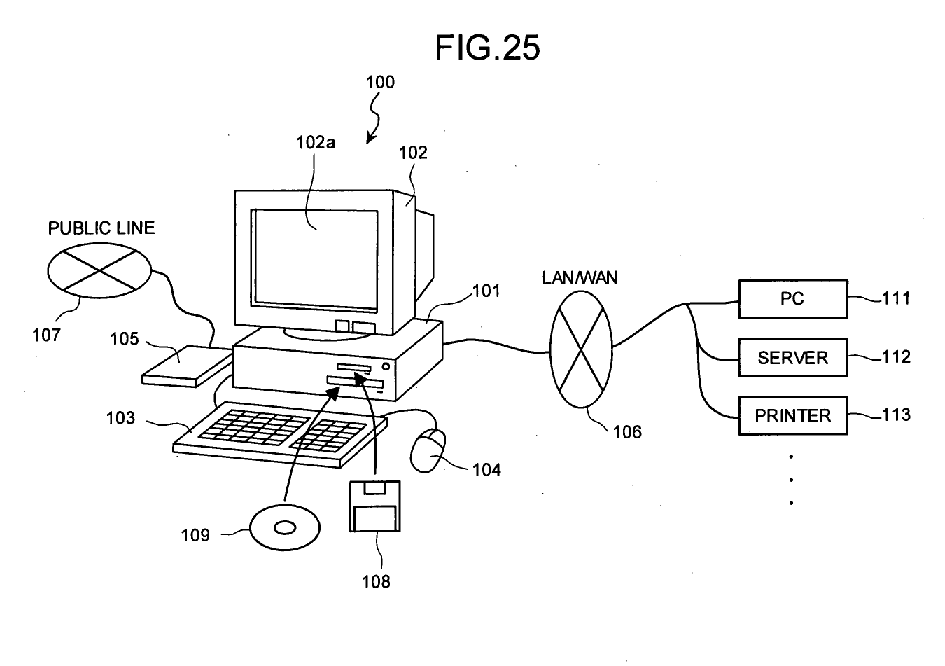

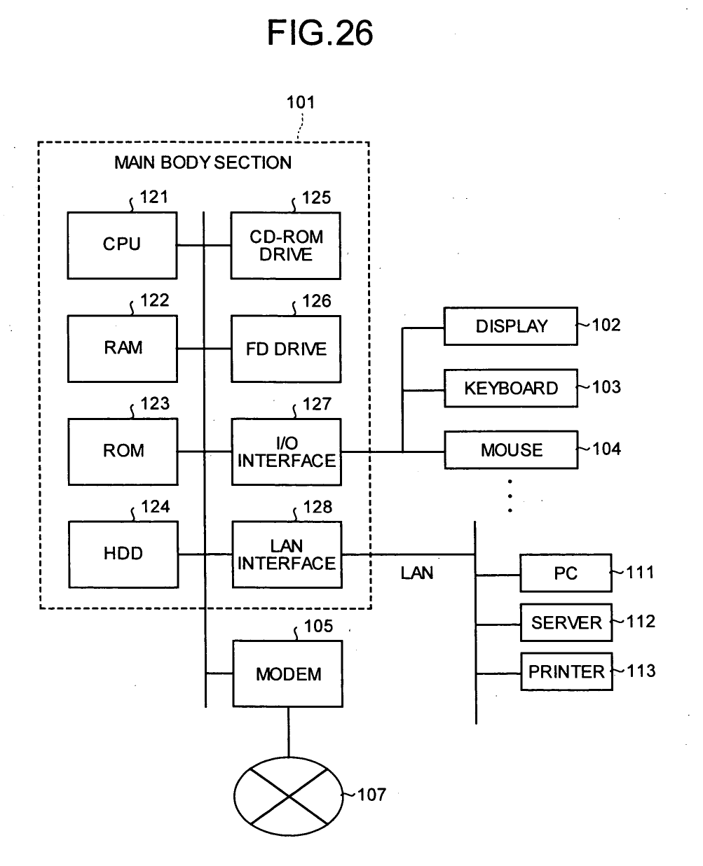

FIG. 25 is a system block diagram of the configuration of the computer system in the fourth embodiment. FIG. 26 is a block diagram of the configuration of a main body section of this computer system. As shown in FIG. 25, the computer system 100 in the fourth embodiment includes the main body section 101, a display 102 which displays information such as an image on a display screen 102a in response to a command from the main body section 101, a keyboard 103 for inputting various pieces of information to the computer system 100, and a mouse 104 for designating an arbitrary position on the display screen 102a of the display 102.

As shown in FIG. 26, the main body section 101 of the computer system 100 includes a central processing unit (CPU) 121, a random access memory (RAM) 122, a read only memory (ROM) 123, a hard disk drive (HDD) 124, a CD-ROM drive 125 which receives a CD-ROM 109, an flexible disk (FD) drive 126 which receives an FD 108, an I/O interface 127 to which the display 102, the keyboard 103, and the mouse 104 are connected, and a LAN interface 128 connected to a local area network or a wide area network (LAN/WAN) 106.

A modem 105 for connecting the computer system 100 to a public line 107 such as the Internet is connected to this computer system 100. In addition, the other computer system (hereinafter, “PC”) 111, a server 112, a printer 113, and the like are connected to the computer system 100 through the LAN interface 128 and the LAN/WAN 106.

This computer system 100 realizes the router control device (or the router control method) by reading and executing a router control program recorded on a predetermined recording medium. Examples of the predetermined recording medium include any types of recording mediums that record the packet processing program readable by the computer system, for example, “portable physical mediums” such as the FD 108, the CD-ROM 109, a magneto-optical (MO) disk, a digital versatile disk (DVD), and an IC card, “fixed physical mediums” such as the HDD 124, the RAM 122, and the ROM 123 provided inside or outside of the computer system 100, and “communication mediums” such as the public line 107 connected to the computer system 100 through the modem 105 and the LAN/WAN 106 to which the other computer system 111 and the server 112 are connected, which hold the program for a short period of time if the program is transmitted.

Namely, the router control program is recorded on the recording medium such as the “portable physical medium”, “fixed physical medium” or “communication medium” in a computer readable manner. The computer system 100 reads and executes the packet processing program from such a recording medium and thereby realizes the router control device or the router control method. The router control program is not limited to the program executed by the computer system. The present invention can be similarly applied to an instance in which the router control program is executed by the other computer system 111, the server 112, or a combination thereof.

The first to the fourth embodiments of the present invention have been explained so far. However, the present invention can be carried out by various other embodiments besides the first to the fourth embodiments explained so far, within the scope of the technical concept defined by claims which follow.

For example, in the first embodiment, after setting the virtual I/F, the virtual communication path is set on occasion of the activation of the routing section 210. However, the present invention is not limited to the example and the order of setting the virtual I/F and activating the routing section can be changed.

Among the processings explained so far in the embodiments, all of or part of the processings which have been explained that they are carried out automatically can be carried out manually or all of or part of those which have been explained that they are carried out manually can be carried out automatically by a well-known method. Further, the processing procedures, the control procedures, the specific names, and the information including various pieces of data and parameters explained in the specification and shown in the drawings can be arbitrarily changed unless specified otherwise.

Moreover, the respective constituent elements of the control device and the forwarder shown in the drawings are functionally conceptual and are not necessarily physically constituted as shown in the drawings. Namely, the concrete manners of distribution and integration of the control device and the forwarder are not limited to those shown in the drawings but all of or part of the constituent elements can be distributed and integrated functionally or physically in arbitrary units. Furthermore, all of or part of the respective processing functions carried out by the control device and the forwarder can be realized by the CPU and a program analyzed and executed by the CPU or realized as wired logic hardware.

As explained so far, according to a first aspect of the present invention, a packet control system is constituted so that the packet forwarder transfers a routing information packet received at a network interface to a packet control device, and so that the packet control device holds address information made to associate with the network interface, receives the routing information packet transferred from the packet forwarder and transfers the routing information packet to the routing process while making the routing information packet associate with the virtual interface, and receives the routing information packet delivered by the routing process while the routing information packet is made to associate with the virtual interface and transfers the routing information packet to the packet forwarder. Therefore, It is possible to provide an operation environment equivalent to that in which a routing application operating on the packet control device operates on the packet forwarder. Hence, the forwarding function and the control function of the router can be separated and cooperated without modifying the conventionally used routing application.

According to a second aspect of the present invention, a packet control device is constituted to include a virtual interface which holds address information made to associate with the network interface, receive a routing information packet transferred from a packet forwarder and transfer the routing information packet to a routing process while making the routing information packet associate with the virtual interface, and receive the routing information packet delivered by the routing process while the routing information packet is made to associate with the virtual interface and transfers the routing information packet to the packet forwarder. Therefore, It is possible to provide an operation environment equivalent to that in which a routing application operating on the packet control device operates on the packet forwarder. Hence, the forwarding function and the control function of the router can be separated and cooperated without modifying the conventionally used routing application.

According to a third aspect of the present invention, the packet control device is constituted so that the virtual interface made to associate with the network interface of the packet forwarder and an interface of the packet control device are grouped, respectively, and so that the packet is routed using the routing process for each group. Therefore, the forwarding function and the control function of the router can be separated and cooperated without modifying the conventionally used routing application.

According to a fourth aspect of the present invention, the packet control device is constituted so that if a plurality of the packet forwarders are connected to the packet control device, the virtual interfaces corresponding to network interfaces of the respective packet forwarders are grouped, and so that the packet is routed using the routing process for each group. Therefore, a plurality of packet forwarders can be controlled and the forwarding function and the control function of the router can be separated and cooperated without modifying the conventionally used routing application.

According to a fifth aspect of the present invention, the packet control device is constituted to acquire a routing table updated by the routing process and transfer the routing table to the packet forwarder. Therefore, it is possible to always acquire the latest routing table and transmit the routing table to the packet forwarder.

According to a sixth aspect of the present invention, the packet forwarder is constituted to transfer a routing information packet received at a network interface to a packet control device. Therefore, the routing process can route the packet based on routing information on the routing information packet.

According to a seventh aspect of the present invention, the packet forwarder is constituted to receive a routing table transmitted by the packet control device and set the received routing table to the packet forwarder. Therefore, the packet can be transmitted and received using the network I/F based on the latest routing table.

According to an eighth aspect of the present invention, a packet control method is constituted to hold address information made to associate with a network interface as virtual interface, receive a routing information packet transferred from the packet forwarder, transfer the routing information packet to the routing process while making the routing information packet associate with the virtual interface, receive the routing information packet delivered by the routing process while the routing information packet is made to associate with the virtual interface, and transfer the routing information packet to the packet forwarder. Therefore, It is possible to provide an operation environment equivalent to that in which a routing application operating on the packet control device operates on the packet forwarder. Hence, the forwarding function and the control function of the router can be separated and cooperated without modifying the conventionally used routing application.

According to a ninth aspect of the present invention, a packet control method is constituted to group the virtual interface made to associate with the network interface of the packet forwarder and an interface of the packet control device, respectively and route the packet using the routing process for each group. Therefore, the forwarding function and the control function of the router can be separated and cooperated without modifying the conventionally used routing application.

According to a tenth aspect of the present invention, the packet control method is constituted to group the virtual interfaces corresponding to network interfaces of the respective packet forwarders if a plurality of the packet forwarders are connected to the packet control device, and to route the packet using the routing process for each group. Therefore, a plurality of packet forwarders can be controlled and the forwarding function and the control function of the router can be separated and cooperated without modifying the conventionally used routing application.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A packet control system comprising:
a packet forwarder that transfers a packet received from a network interface to another network interface; and
a packet control device that routes the packet using a routing process, wherein
the packet forwarder includes
a received packet transfer unit that transmits to the packet control device a routing information packet received from the network interface, and
the packet control device includes
a virtual interface that has address information associated with the network interface of the packet forwarder;
a transmitted packet reception unit that receives the routing information packet, that associates the routing information packet with the virtual interface, and that delivers the routing information packet to the routing process; and
a transmitted packet transfer unit that receives the routing information packet sent by the routing process, and that transmits the routing information packet to the packet forwarder.

2. A packet control device which constructs a routing table for a packer forwarder controlled by the packet control device, using a routing process running on the packet control device, the packet control device comprising:
a virtual interface that has address information associated with the network interface of the packet forwarder;
a transmitted packet reception unit that receives the routing information packet transmitted from the packet forwarder, that associates the routing information packet with the virtual interface corresponding to an incoming network interface of the packet forwarder, and that transmits the routing information packet to the routing process; and
a transmitted packet transfer unit that receives the routing information packet sent by the routing process, and that transmits the routing information packet to the packet forwarder.

3. The packet control device according to claim 2, further comprising:
a routing table transfer unit that acquires a routing table updated by the routing process, and that transmits the routing table to the packet forwarder.

4. A packet control device which constructs a routing table for a packet forwarder controlled by the packet control device which determines an outgoing network interface of the packet received at an incoming network interface of the packet forwarder, the packet control device comprising:
a plurality of network interfaces; and
a plurality of virtual interfaces each having address information that is associated with one of the network interfaces of the packet forwarder, the network interfaces of the packet control device and the virtual interfaces being divided into a plurality of groups, wherein
the packet control device routes the packet using a routing process associated with each of the groups considering interfaces belongs to the groups to create a dedicated routing table for each, the each of the groups corresponds to a separate device.

5. The packet control device according to claim 4, wherein
the virtual interfaces are grouped for each packet forwarder, and
the packet control device maintains routing tables using a routing process associated with each of the virtual interfaces grouped.

6. A packet forwarder which forwards a packet from its network interface to its other network interface according to its routing table, comprising a received packet transfer unit that transmits a routing information packet received at the network interface to a packet control device that maintains the routing table of the packet forwarder using a routing process.

7. The packet forwarder according to claim 6, further comprising a routing table setting unit that receives a routing table from the packet control device, and that sets the routing table to the packet forwarder.

8. A method of maintaining a routing table using a routing process, the method comprising:
receiving a routing information packet which is received by a packet forwarder;
associating the routing information packet with a virtual interface that has address information associated with a network interface of the packet forwarder;
delivering the routing information packet to the routing process;
receiving the routing information packet sent by the routing process; and
transmitting the routing information packet to the packet forwarder for transmitting from its network interface.

9. The method according to claim 8, further comprising:
acquiring a routing table updated by the routing process; and
transmitting the routing table to the packet forwarder.

10. A method of maintaining a routing table in a system that includes a packet forwarder and a packet control device, the packet forwarder including a plurality of network interfaces, the packet control device including a plurality of network interface and a plurality of virtual interfaces each having address information that is associated with one of the network interfaces of the packet forwarder, the method comprising:
dividing the network interfaces of the packet control device and the virtual interfaces into a plurality of groups; and
maintaining a routing table of each of the group using a routing process associated with each of the groups.

11. The method according to claim 10, wherein the virtual interfaces are grouped for each packet forwarder, further comprising maintaining a routing table of each packet forwarder using a routing process associated with each of the virtual interfaces grouped.

12. A method of maintaining a routing table of a packet forwarder, the method comprising:
receiving a routing information packet from a network interface of a packet forwarder; and
transferring the routing information packet to a packet control device.

13. The method according to claim 12, further comprising:
receiving a routing table from a packet control device; and
setting the routing table to the packet forwarder.

14. A computer program product for routing a packet using a routing process, including computer executable instructions stored on a computer readable medium, wherein the instructions, when executed by the computer, cause the computer to perform:
receiving a routing information packet from a network interface of a packet forwarder;
transmitting the routing information packet to a packet control device;
receiving the routing information packet from the packet forwarder;
associating the routing information packet with a virtual interface that has address information associated with the network interface;
transmitting the routing information packet to the routing process;
receiving the routing information packet transmitted from the routing process; and
transmitting the routing information packet to the packet forwarder.

15. The computer program product according to claim 14, wherein the instructions further cause the computer to perform:
acquiring a routing table updated by the routing process; and
transmitting the routing table to the packet forwarder.

16. A computer program product for maintaining a routing table, the packet forwarder including a plurality of network interfaces, the packet control device including a plurality of network interfaces and a plurality of virtual interfaces each having address information that is associated with one of the network interfaces of the packet forwarder, the computer program product including computer executable instructions stored on a computer readable medium, wherein the instructions, when executed by the computer, cause the computer to perform:
dividing the network interfaces of the packet control device and the virtual interfaces into a plurality of groups; and
maintaining a routing table of each of the groups using a routing process associated with each of the groups.

17. The computer program product according to claim 16, wherein the virtual interfaces are grouped for each packet forwarder, and the instructions further cause the computer to perform maintaining a routing table of each packet forwarder using a routing process associated with each of the virtual interfaces grouped.

18. A computer program product for maintaining a routing table of a packet forwarder, including computer executable instructions stored on a computer readable medium, wherein the instructions, when executed by the computer, cause the computer to perform:
receiving a routing information packet from a network interface of the packet forwarder; and
transferring the routing information packet to the packet control device.

19. The computer program product according to claim 18, wherein the instructions further cause the computer to perform:
receiving a routing table from a packet control device; and
setting the routing table to the packet forwarder.

20. A router control device comprising:
a virtual interface setting unit that creates and manages virtual interfaces on a router control device according to corresponding network interfaces of a forwarder;
a routing unit that generates a routing table for the forwarder based on routing information in routing information packets received at the network interface of the forwarder and transferred by the forwarder to the router control device; and
a routing information storage unit that stores a routing table created and managed by the routing unit for packet forwarding between the virtual interfaces.

21. The router control device according to claim 20, further comprising a tunnel transfer unit that transfers the routing information packet via a communication path that connects between the network interface and the virtual interface, wherein
the routing information storage unit stores the routing information in the routing information packet transferred by the tunnel transfer unit, and
the routing unit generates the routing table for the forwarder based on the routing information stored in the routing information storage unit.

22. The router control device according to claim 20, further comprising:
a routing table transmission unit that acquires the routing table and that transmits the routing table to the forwarder, wherein
the routing unit generates the routing table for the forwarder based on the routing information stored in the routing information storage unit.

23. A router control system which includes a forwarder and a router control device, wherein
the router control device includes
a virtual interface setting unit that that creates and manages virtual interfaces on a router control device according to corresponding network interfaces of a forwarder;
a tunnel transfer unit that transfers the routing information packet via a communication path that connects between the network interface and the virtual interface;
a routing information storage unit that stores routing information in the routing information packet transferred by the tunnel transfer unit;
a routing unit that generates the routing table for the forwarder based on the routing information stored in the routing information storage unit; and
the routing table transmission unit that acquires the routing table, and transmits the routing table to the forwarder, and
the forwarder forwards a packet from its network interface to its other network interface according to its routing table, and includes a received packet transfer unit that transmits a routing information packet received at the network interface to the router control device that maintains the routing table of the forwarder using a routing process.

24. A method of maintaining a routing table, comprising:
creating and managing virtual interfaces on a router control device according to corresponding network interfaces of a forwarder;
generating a routing table for the forwarder based on routing information in routing information packets received at the network interface of the forwarder and transferred by the forwarder to the router control device; and
storing a routing table created and managed by the routing unit for packet forwarding between the virtual interfaces.

25. The method according to claim 24, further comprising transferring the routing information packet via a communication path that connects between the network interface and the virtual interface, wherein
the storing includes storing the routing information in the routing information packet transferred by the tunnel transfer unit, and
the generating includes generating the routing table for the forwarder based on the routing information stored.

26. The method according to claim 24, further comprising:
acquiring the routing table; and
transmitting the routing table to the forwarder, wherein
the generating includes generating the routing table for the forwarder based on the routing information stored.

27. A method of maintaining a routing table, comprising:
creating and managing virtual interfaces on a router control device according to corresponding network interfaces of a forwarder;
transferring the routing information packet by tunneling via a communication path that connects between the network interface and the virtual interface;
storing routing information on the routing information in the routing information packet transferred;
generating a routing table for the forwarder based on the routing information stored;
acquiring the routing table;
transmitting the routing table to the forwarder;
forwarding a packet from a network interface of the forwarder to other network interface of the forwarder according to a routing table of the forwarder; and
transmitting a routing information packet received at the network interface of the forwarder to the router control device that maintains the routing table of the forwarder using a routing process.

28. A computer program product for maintaining a routing table, including computer executable instructions stored on a computer readable medium, wherein the instructions, when executed by the computer, cause the computer to perform:
creating and managing virtual interfaces on a router control device according to corresponding network interfaces of a forwarder;
generating a routing table for the forwarder based on routing information in routing information packets received at the network interface of the forwarder and transferred by the forwarder to the router control device; and
storing a routing table created and managed by the routing unit for packet forwarding between the virtual interfaces.

29. The computer program product according to claim 28, wherein the instructions further cause the computer to perform transferring the routing information packet via a communication path that connects between the network interface and the virtual interface, wherein
the storing includes storing the routing information in the routing information packet transferred by the tunnel transfer unit, and
the generating includes generating the routing table for the forwarder based on the routing information stored.

30. The computer program product according to claim 28, wherein the instructions further cause the computer to perform:
acquiring the routing table; and
transmitting the routing table to the forwarder, wherein
the generating includes generating the routing table for the forwarder based on the routing information stored.

31. A computer program product for maintaining a routing table, including computer executable instructions stored on a computer readable medium, wherein the instructions, when executed by the computer, cause the computer to perform:
creating and managing virtual interfaces on a router control device according to corresponding network interfaces of a forwarder;
transferring the routing information packet by tunneling via a communication path that connects between the network interface and the virtual interface;
storing routing information on the routing information in the routing information packet transferred;
generating a routing table for the forwarder based on the routing information stored;
acquiring the routing table;
transmitting the routing table to the forwarder;
forwarding a packet from a network interface of the forwarder to other network interface of the forwarder according to a routing table of the forwarder; and
transmitting a routing information packet received at the network interface of the forwarder to the router control device that maintains the routing table of the forwarder using a routing process.
